(19) United States
(12) Patent Application Publication
(10) Pub. No.: US 2025/0056488 A1
(43) Pub. Date: Feb. 13, 2025

(54) ENHANCED POSITIONING FRAMEWORK INCLUDING SUPPORT TO AI/ML

(71) Applicant: FRAUNHOFER-GESELLSCHAFT ZUR FOERDERUNG DER ANGEWANDTEN FORSCHUNG E.V., Muenchen (DE)

(72) Inventors: Mohammad ALAWIEH, Erlangen (DE); Birendra GHIMIRE, Erlangen (DE); Ernst EBERLEIN, Erlangen (DE); Tobias FEIGL, Erlangen (DE); Christopher MUTSCHLER, Erlangen (DE); Maximilian STAHLKE, Erlangen (DE); Norbert FRANKE, Erlangen (DE); Thomas VON DER GRUEN, Erlangen (DE)

(21) Appl. No.: 18/929,060

(22) Filed: Oct. 28, 2024

Related U.S. Application Data
(63) Continuation of application No. PCT/EP2023/061334, filed on Apr. 28, 2023.

(30) Foreign Application Priority Data
Apr. 29, 2022 (EP) 22171056.9

(51) Int. Cl. H04W 64/00; H04W 8/22; H04W 24/02

(52) U.S. Cl. CPC H04W 64/00; H04W 8/22; H04W 24/02

(57) ABSTRACT

A user equipment of a wireless communication system according to an embodiment is provided. The user equipment is configured to determine and/or to receive information on an applicability of a machine-learning model. And/or, the user equipment is configured to determine and/or to receive information that the user equipment is located in a machine-learning assisted area.

### CROSS-REFERENCE TO RELATED APPLICATION

This application is a continuation of copending International Application No. PCT/EP2023/061334, filed Apr. 28, 2023, which is incorporated herein by reference in its entirety, and additionally claims priority from European Application No. 22171056.9, filed Apr. 29, 2022, which is also incorporated herein by reference in its entirety.

### TECHNICAL FIELD

The present invention relates to the field of wireless communication systems or networks, more specifically to an apparatus and a method for providing a modified OFDM frame structure.

### BACKGROUND OF THE INVENTION

FIG. 18 is a schematic representation of an example of a terrestrial wireless network 100 including, as is shown in FIG. 18(a), the core network and one or more radio access networks RAN₁, RAN₂, . . . . RAN_{N} (RAN=Radio Access Network). FIG. 18(b) is a schematic representation of an example of a radio access network RANₙ that may include one or more base stations gNB₁ to gNB₅ (gNB=next generation Node B), each serving a specific area surrounding the base station schematically represented by respective cells 1061 to 1065. The base stations are provided to serve users within a cell. The one or more base stations may serve users in licensed and/or unlicensed bands. The term base station, BS, refers to a gNB in 5G networks, an eNB in UMTS/LTE/LTE-A/LTE-A Pro, or just a BS in other mobile communication standards. A user may be a stationary device or a mobile device. The wireless communication system may also be accessed by mobile or stationary IoT (Internet of Things) devices which connect to a base station or to a user. The mobile devices or the IoT devices may include physical devices, ground based vehicles, such as robots or cars, aerial vehicles, such as manned or unmanned aerial vehicles, UAVs, the latter also referred to as drones, buildings and other items or devices having embedded therein electronics, software, sensors, actuators, or the like as well as network connectivity that enables these devices to collect and exchange data across an existing network infrastructure. FIG. 18(b) shows an exemplary view of five cells, however, the RANₙ may include more or less such cells, and RANₙ may also include only one base station. FIG. 18(b) shows two users UE₁ and UE₂, (UE=User Equipment) also referred to as user equipment, UE, that are in cell 1062 and that are served by base station gNB₂. Another user UE₃ is shown in cell 106₄ which is served by base station gNB₄. The arrows 108₁, 108₂ and 108₃ schematically represent uplink/downlink connections for transmitting data from a user UE₁, UE₂ and UE₃ to the base stations gNB₂, gNB₄ or for transmitting data from the base stations gNB₂, gNB₄ to the users UE₁, UE₂, UE₃. This may be realized on licensed bands or on unlicensed bands. Further, FIG. 18(b) shows two IoT devices 110₁ and 110₂ in cell 106₄, which may be stationary or mobile devices. The IoT device 110₁ accesses the wireless communication system via the base station gNB₄ to receive and transmit data as schematically represented by arrow 112₁. The IoT device 110₂ accesses the wireless communication system via the user UE₃ as is schematically represented by arrow 1122. The respective base stations gNB₁ to gNB₅ may be connected to the core network 102, e.g. via the S1 interface, via respective backhaul links 114₁ to 114₅, which are schematically represented in FIG. 18(b) by the arrows pointing to “core”. The core network 102 may be connected to one or more external networks. The external network may be the Internet or a private network, such as an intranet or any other type of campus networks, e.g. a private WiFi or 4G or 5G mobile communication system. Further, some or all of the respective base stations gNB₁ to gNB₅ may be connected, e.g. via the S1 or X2 interface or the XN interface in NR (New Radio), with each other via respective backhaul links 116₁ to 116₅, which are schematically represented in FIG. 18(b) by the arrows pointing to “gNBs”. A sidelink channel allows direct communication between UEs, also referred to as device-to-device, D2D (Device to Device), communication. The sidelink interface in 3GPP (3G Partnership Project) is named PC5 (Proximity-based Communication 5).

For data transmission a physical resource grid may be used. The physical resource grid may comprise a set of resource elements to which various physical channels and physical signals are mapped. For example, the physical channels may include the physical downlink, uplink and sidelink shared channels, PDSCH (Physical Downlink Shared CHannel), PUSCH (Physical Uplink Shared Channel), PSSCH (Physical Sidelink Shared Channel), carrying user specific data, also referred to as downlink, uplink and sidelink payload data, the physical broadcast channel, PBCH (Physical Broadcast Channel), carrying for example a master information block, MIB, and one or more of a system information block, SIB, one or more sidelink information blocks, SLIBs, if supported, the physical downlink, uplink and sidelink control channels, PDCCH (Physical Downlink Control Channel), PUCCH (Physical Uplink Control CHannel), PSCCH (Physical Sidelink Control Channel), the downlink control information, DCI, the uplink control information, UCI, and the sidelink control information, SCI, and physical sidelink feedback channels, PSFCH (Physical sidelink feedback channel), carrying PC5 feedback responses. Note, the sidelink interface may support a 2-stage SCI (Speech Call Items). This refers to a first control region comprising some parts of the SCI, and, optionally, a second control region, which comprises a second part of control information.

For the uplink, the physical channels may further include the physical random-access channel, PRACH (Packet Random Access Channel) or RACH (Random Access Channel), used by UEs for accessing the network once a UE synchronized and obtained the MIB and SIB. The physical signals may comprise reference signals or symbols, RS, synchronization signals and the like. The resource grid may comprise a frame or radio frame having a certain duration in the time domain and having a given bandwidth in the frequency domain. The frame may have a certain number of subframes of a predefined length, e.g. 1 ms. Each subframe may include one or more slots of 12 or 14 OFDM symbols (OFDM=Orthogonal Frequency-Division Multiplexing) depending on the cyclic prefix, CP, length. A frame may also include of a smaller number of OFDM symbols, e.g. when utilizing a shortened transmission time interval, sTTI (slot or subslot transmission time interval), or a mini-slot/non-slot-based frame structure comprising just a few OFDM symbols.

The wireless communication system may be any single-tone or multicarrier system using frequency-division multiplexing, like orthogonal frequency-division multiplexing, OFDM, or orthogonal frequency-division multiple access, OFDMA (Orthogonal frequency-division multiple access), or any other IFFT-based signal (IFFT=Inverse Fast Fourier Transformation) with or without CP, e.g. DFT-s-OFDM (DFT=discrete Fourier transform). Other waveforms, like non-orthogonal waveforms for multiple access, e.g. filter-bank multicarrier, FBMC, generalized frequency division multiplexing, GFDM, or universal filtered multi carrier, UFMC, may be used. The wireless communication system may operate, e.g., in accordance with the LTE-Advanced pro standard, or the 5G or NR, New Radio, standard, or the NR-U, New Radio Unlicensed, standard.

The wireless network or communication system depicted in FIG. 18 may be a heterogeneous network having distinct overlaid networks, e.g., a network of macro cells with each macro cell including a macro base station, like base stations gNB₁ to gNB₅, and a network of small cell base stations, not shown in FIG. 18, like femto or pico base stations. In addition to the above described terrestrial wireless network also non-terrestrial wireless communication networks, NTN, exist including spaceborne transceivers, like satellites, and/or airborne transceivers, like unmanned aircraft systems. The non-terrestrial wireless communication network or system may operate in a similar way as the terrestrial system described above with reference to FIG. 18, for example in accordance with the LTE-Advanced Pro standard or the 5G or NR, new radio, standard.

In mobile communication networks, for example in a network like that described above with reference to FIG. 18, like an LTE or 5G/NR network, there may be UEs that communicate directly with each other over one or more sidelink, SL, channels, e.g., using the PC5/PC3 interface or WiFi direct. UEs that communicate directly with each other over the sidelink may include vehicles communicating directly with other vehicles, V2V communication, vehicles communicating with other entities of the wireless communication network, V2X communication, for example roadside units, RSUs, or roadside entities, like traffic lights, traffic signs, or pedestrians. An RSU may have a functionality of a BS or of a UE, depending on the specific network configuration. Other UEs may not be vehicular related UEs and may comprise any of the above-mentioned devices. Such devices may also communicate directly with each other, D2D communication, using the SL channels.

In a wireless communication network, like the one depicted in FIG. 18, it may be desired to locate a UE with a certain accuracy, e.g., determine a position of the UE in a cell. Several positioning approaches are known, like satellite-based positioning approaches, e.g., autonomous and assisted global navigation satellite systems, A-GNSS, such as GPS, mobile radio cellular positioning approaches, e.g., observed time difference of arrival, OTDOA, and enhanced cell ID, E-CID, or combinations thereof.

High accuracy positioning is typically based on line-of-sight (LOS) signals, where the first signal arrives with a time-of-flight (ToF) according to the distance and the speed-of-light relative to the transmit time. Transmitting or receiving the signal from TRP (transmit and receive point) with known position (“anchor” for positioning) and trilateration and/or triangulation or other positioning algorithms the position can be determined.

There may be areas in a network where the UE may not have sufficient number of anchors, e.g., TRPs with known position, reachable under LOS condition. Thus, the accuracy of the estimate of a corresponding UE position may deteriorate. A brute-force solution is to increase the number of TRPs (densification of TRPs) so that the UE can always find at least the minimum number of TRPs with LOS condition for the given positioning method. However, this approach does not scale and also cannot adjust to change in the environment. And of course, there can be situations in which not enough TRPs—either at LOS or NLOS condition—can be reached and the positional accuracy may further decrease.

Methods based on detailed analysis of the received signal (mainly the channel impulse response (CIR) with or without angle information) may be able to work under NLOS conditions also, but these methods need detailed information of the environment. An example is ray-tracing based approaches predict the CIR characteristics for NLOS conditions. Another examples are realized in that the characteristics of the received signals (signal strength, CIR, angle of arrival (AoA) information, etc. or a subset of it) is measured in a “training phase” and stored as a fingerprint, for example.

Both examples may suffer from changes in the environment, which may require an update of the data captured in the training phase or generated by other methods.

3GPP's Rel-16 introduced different UL and DL positioning methods to support timing and angular based solutions for 5G positioning. In Rel-17, accuracy enhancements focused on the LOS and NLOS classification and additional path reporting in addition to introducing RSRP measurements. Nevertheless, NR positioning solutions are dependent on the LOS conditions while NR positioning solutions in NLOS were left for discussions in Rel-18 since approaches are mostly AI/ML related or enabled.

It would be appreciated, if improved concepts for positioning in wireless communication systems would be provided.

### SUMMARY

A user equipment of a wireless communication system according to an embodiment is provided. The user equipment is configured to determine and/or to receive information on an applicability of a machine-learning model. And/or, the user equipment is configured to determine and/or to receive information that the user equipment is located in a machine-learning assisted area.

Moreover, a user equipment of a wireless communication system according to an embodiment is provided. The user equipment is configured to determine if it shall act as a temporal anchor unit, for example as a temporal anchor or as a temporal PRU or as a PRU, depending on the temporal reference information.

Furthermore, a user equipment of a wireless communication system according to an embodiment is provided. The user equipment is configured to obtain information on its position and/or to obtain information on a distance between the user equipment and another entity, for example another user equipment, of the wireless communication system, for example ranging information. The information is obtained by receiving, for example via a direct communication link or indirectly through the network, information from another user equipment which acts as a temporal anchor unit, for example a temporal anchor or a temporal PRU or a PRU, wherein said information received from the temporal anchor unit comprises a position of the temporal anchor unit and/or one or more measurements performed by the temporal anchor unit on signals transmitted by the user equipment, or wherein said information comprises a position reference signal. Moreover, the information is obtained by performing one or more measurements on one or more received signals, and/or by transmitting to a network entity, for example to a LMF or to a NWDAF, derived information derived from said measurements of the wireless communication system.

Moreover, a user equipment of a wireless communication system according to an embodiment is provided. The user equipment, for example being an UL-TDOA device, is configured to support an entity, for example a network entity, of the wireless communication system to obtain information on a position of the user equipment and/or to obtain information on a distance between the user equipment and another entity, for example another user equipment, of the wireless communication system, for example ranging information, by transmitting, for example via a direct communication link or indirectly through the network, one or more reference signals to a another user equipment which acts as a temporal anchor unit, for example a temporal anchor or a temporal PRU or a PRU, to allow the temporal anchor to conduct one or more measurements on the one or more reference signals and/or to report the one or more measurements to said entity of the wireless communication system.

Furthermore, a user equipment of a wireless communication system according to an embodiment is provided. The user equipment is configured to determine, for example by using a RAT-independent technology and/or by using a RAT-dependent technology and/or by using a temporal anchor, or is configured to receive, information on its position, and/or information on a distance between the user equipment and another entity, for example another user equipment, of the wireless communication system, for example ranging information. Moreover, the user equipment is configured to assist in generating training data for a machine-learning model for positioning using the information on its position and/or the information on said distance, for example for machine learning with related labels.

Moreover, a user equipment of a wireless communication system according to an embodiment is provided. The user equipment is configured to transmit information on one or more properties of RF channel characteristics between the user equipment and another entity of the wireless communication system and/or an indicator on the probability that a direct path (“line-of-sight” path) exists and/or information on the characteristics of one or more RF channel propagation paths not related to the direct path, wherein the other entity of the wireless communication system is a base station or is another user equipment of the wireless communication system. Furthermore, the user equipment is configured to report, to said other entity or to a further entity of the wireless communication system, information on one or more channel impulse responses.

Furthermore, a user equipment of a wireless communication system is provided. The user equipment is configured to receive measurement and/or transmission characteristics information.

Moreover, a user equipment of a wireless communication system according to an embodiment is provided. The user equipment is configured to receive from a network entity of the wireless communication system one or more PRS configurations for one or more antennas of one or more transmitting devices of the wireless communication system. Moreover, the user equipment is configured to receive from a network entity of the wireless communication system measurement and/or transmission characteristics information comprising a set of one or more parameters. Furthermore, the user equipment is configured to determine, using the one or more PRS configurations and using the measurement and/or transmission characteristics information, its position and/or information on a distance between the user equipment and another entity, for example another user equipment, of the wireless communication system, for example ranging information.

Moreover, a network entity of a wireless communication system according to an embodiment is provided. The network entity is configured to transmit to a user equipment of the wireless communication system temporal reference information for enabling the user equipment to determine if it is able to act as a temporal anchor unit, for example as a temporal anchor or as a temporal PRU or as a PRU. If the user equipment has determined that it shall act as a temporal anchor unit, the network entity is configured to receive from the user equipment information on its position and/or on one or more measurements and/or on a position reference signal; and/or on a distance between the user equipment and another entity, for example another user equipment, of the wireless communication system, for example ranging information.

Furthermore, a network entity of a wireless communication system according to an embodiment is provided. The network entity is configured to receive information from a user equipment of the wireless communication system on one or more line-of-sight links, for example defined by that an RF channel including a direct path with a delay according to the distance, or on one or more properties or one or more characteristics of one or more RF channels between network entities or a non-presence of a line-of-sight links to another entity, for example to another network entity, of the wireless communication system.

Moreover, a network entity of a wireless communication system according to an embodiment is provided. If a user equipment of the wireless communication system shall act as a temporal anchor unit. The network entity is configured to receive information on one or more measurements from the user equipment, for example one or more measurements performed on a position reference signal transmitted by the device. Moreover, the network entity is configured to determine a position of the device and/or to determine a distance between the user equipment and the device, using information on a position of the user equipment and using the information on the one or more measurements.

Furthermore, a network entity of a wireless communication system according to an embodiment is provided. The network entity is configured to transmit measurement and/or transmission characteristics information, for example, ACS information (Association and Calibration Spots information), to a user equipment of the wireless communication system, wherein the measurement and/or transmission characteristics information is associated with one or more TRPs and is further associated with a geographical region.

Moreover, a network entity of a wireless communication system according to an embodiment is provided. The network entity is configured to transmit to a user equipment of the wireless communication system one or more PRS configurations for one or more antennas of one or more transmitting devices of the wireless communication system. The network entity is configured to transmit to the user equipment of the wireless communication system measurement and/or transmission characteristics information, for example, ACS information (Association and Calibration Spots information), comprising a set of one or more parameters, for example wherein the measurement and/or transmission characteristics information comprises information on the relationship between an ACS-ID and assistance data, for example wherein the assistance data comprises a PRS configuration.

Moreover, a wireless communication system, comprising one or more user equipments as described above and one or more network entities as described above according to embodiments is provided.

Furthermore, a wireless communication system according to an embodiment is provided. The wireless communication system comprises at least two entities, wherein each of the at least two entities is a user equipment or is a network entity, wherein the at least two entities comprise a first entity and a second entity. The first entity is configured to determine, if it shall act as a temporal anchor unit, for example as a temporal anchor or as a temporal PRU or as a PRU, depending on temporal reference information. The second network entity is configured to perform one or more measurements and is configured to provide one or more reports derived from the one or more measurements to a another network entity, for example to an LMF or to an NWDAF, to train a model, for example neural network, or to capture the characteristics of one or more RF signals received in an area.

Furthermore, a wireless communication system according to an embodiment is provided. At least one of the plurality of entities is configured to use one or more measurements of one or more user equipments of the wireless communication system for conducting one or more comparisons. Moreover, at least one of the plurality of entities is configured to conduct unsupervised learning of similar properties or characteristics, for example of one or more channel impulse responses or one or more parameters thereof. At least one of the plurality of entities is configured to employ one or more temporal anchors of the wireless communication system are used for supervised learning. Furthermore, at least one of the plurality of entities is configured to conduct supervised learning for mapping similar properties or characteristics, for example of a channel impulse responses or of parameters thereof, to corresponding reference information, for example to a velocity and/or to an orientation and/or to an acceleration and/or to a position and/or to a distance. At least one of the plurality of entities is configured to train or to collect a ML-model using a combination of supervised, for example with output labels, and unsupervised, for example without output labels, approaches. Furthermore, at least one of the plurality of entities is configured to employ labels that are obtained from one or more temporal anchors are to provide real world dimensions to the trained model, wherein the labels allow to transform, for example to scale and to rotate, the learned representation to a real-world dimension.

Moreover, a method for a wireless communication system according to an embodiment is provided. The method comprises determining, by a user equipment of the wireless communication system, and/or receiving, by the user equipment, information on an applicability of a machine-learning model. And/or, the method comprises determining, by a user equipment of the wireless communication system, and/or receiving, by the user equipment, information that the user equipment is located in a machine-learning assisted area.

Furthermore a method for a wireless communication system according to an embodiment is provided. The method comprises determining if a user equipment of the wireless communication system shall act as a temporal anchor unit, for example as a temporal anchor or as a temporal PRU or as a PRU, depending on the temporal reference information.

Moreover, a method for a wireless communication system according to an embodiment is provided. The method comprises obtaining, by a user equipment of the wireless communication system, information on its position and/or to obtain information on a distance between the user equipment and another entity, for example another user equipment, of the wireless communication system, for example ranging information. Obtaining the information is conducted by receiving, for example via a direct communication link or indirectly through the network, information from another user equipment which acts as a temporal anchor unit, for example a temporal anchor or a temporal PRU or a PRU, wherein said information received from the temporal anchor unit comprises a position of the temporal anchor unit and/or one or more measurements performed by the temporal anchor unit on signals transmitted by the user equipment, or wherein said information comprises a position reference signal. Moreover, obtaining the information is conducted by performing one or more measurements on one or more received signals, and/or by transmitting to a network entity, for example to a LMF or to a NWDAF, derived information derived from said measurements of the wireless communication system.

Furthermore a method for a wireless communication system according to an embodiment is provided. The method comprises supporting, by a user equipment of the wireless communication system, information an entity, for example a network entity, of the wireless communication system to obtain information on a position of the user equipment and/or to obtain information on a distance between the user equipment and another entity, for example another user equipment, of the wireless communication system, for example ranging information, by transmitting, for example via a direct communication link or indirectly through the network, one or more reference signals to a another user equipment which acts as a temporal anchor unit, for example a temporal anchor or a temporal PRU or a PRU, to allow the temporal anchor to conduct one or more measurements on the one or more reference signals and/or to report the one or more measurements to said entity of the wireless communication system.

Moreover, a method for a wireless communication system according to an embodiment is provided. the method comprises determining, for example by using a RAT-independent technology and/or by using a RAT-dependent technology and/or by using a temporal anchor, or receiving, by a user equipment of the wireless communication system, information on a position of the user equipment, and/or information on a distance between the user equipment and another entity, for example another user equipment, of the wireless communication system, for example ranging information, and assisting, by the user equipment, in generating training data for a machine-learning model using the information on its position and/or the information on said distance, for example for machine learning with related labels. For example, the machine-learning model is located on an LMF or on a NWDAF of the wireless communication system.

Furthermore a method for a wireless communication system according to an embodiment is provided. The method comprises transmitting, by a user equipment of the wireless communication system, information on one or more properties of RF channel characteristics between the user equipment and another entity of the wireless communication system and/or an indicator on the probability that a direct path (“line-of-sight” path) exists and/or information on the characteristics of one or more RF channel propagation paths not related to the direct path, wherein the other entity of the wireless communication system is a base station or is another user equipment of the wireless communication system. The method comprises reporting, by the user equipment to said other entity or to a further entity of the wireless communication system, information on one or more channel impulse responses.

Moreover, a method for a wireless communication system according to an embodiment is provided, wherein the method comprises receiving, by a user equipment, measurement and/or transmission characteristics information.

Furthermore, a method for a wireless communication system is provided. The method comprises receiving, by a user equipment, from a network entity of the wireless communication system one or more PRS configurations for one or more antennas of one or more transmitting devices of the wireless communication system. Moreover, the method comprises receiving, by the user equipment, from a network entity of the wireless communication system measurement and/or transmission characteristics information comprising a set of one or more parameters. Furthermore, the method comprises determining, by the user equipment, using the one or more PRS configurations and using the measurement and/or transmission characteristics information, its position and/or information on a distance between the user equipment and another entity, for example another user equipment, of the wireless communication system, for example ranging information.

Moreover, a computer program according to an embodiment for implementing one of the above-described methods, when the computer program is executed by a computer or signal processor is provided.

Some embodiments may, e.g., define methods for management of the related neural networks, methods for continuous updates and related signaling.

### BRIEF DESCRIPTION OF THE DRAWINGS

In the following, embodiments of the present invention are described in more detail with reference to the figures, in which:

FIG. 1 illustrates a user equipment and a network entity of a wireless communication system according to an embodiment;

FIG. 2 illustrates an overview of some of the concepts according to particular embodiments;

FIG. 3 illustrates an example for NLOS positioning;

FIG. 4 illustrates components of a 3GPP network in a non-roaming scenario applicable to positioning;

FIG. 5 illustrates an example procedure to determine UE position at LMF based on a ML model according to an embodiment;

FIG. 6 illustrates an example for obtaining features for training based on ML at the network side;

FIG. 7 illustrates an example stage 2 for UE-based positioning based on ML model and assistance data provided by the network;

FIG. 8 illustrates an association and calibration spot according to an embodiment;

FIG. 9 illustrates examples for ACS information according to embodiments for the scenario of FIG. 8;

FIG. 10 illustrates details on potential pre-processing steps according to embodiments;

FIG. 11 illustrates a scheme of a particular model identification procedure according to an embodiment;

FIG. 12 illustrates an exemplary scheme of a continual model identification procedure according to an embodiment;

FIG. 13 illustrates an exemplary scheme of our proposed supervised learning procedure according to an embodiment;

FIG. 14 illustrates a scheme of an unsupervised learning procedure according to an embodiment;

FIG. 15 illustrates a global perspective on a continual learning procedure according to an embodiment;

FIG. 16 illustrates a processing scheme of a continual and iterative learning pipeline according to an embodiment;

FIG. 17 illustrates an abstract scheme of a model identification procedure according to an embodiment;

FIGS. 18(a)/(b) illustrate a schematic representation of an example of a terrestrial wireless network; and

FIG. 19 illustrates an example of a computer system on which units or modules as well as the steps of the methods described in accordance with the inventive approach may execute.

### DETAILED DESCRIPTION OF THE INVENTION

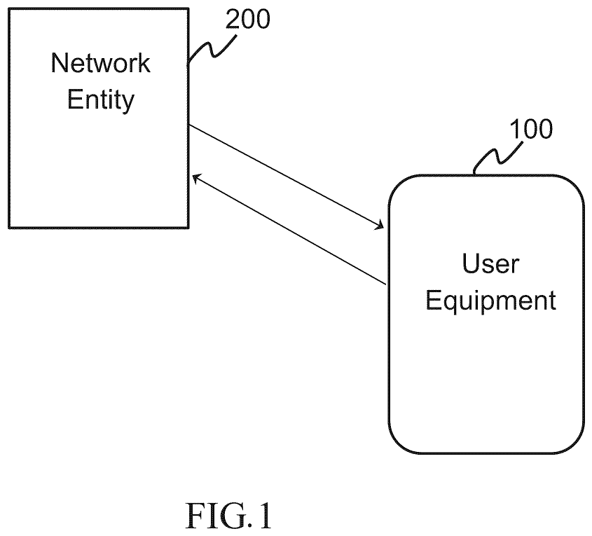

FIG. 1 illustrates a user equipment 100 of a wireless communication system according to an embodiment.

The user equipment 100 is configured to determine and/or to receive information on an applicability of a machine-learning model.

And/or, the user equipment 100 is configured to determine and/or to receive information that the user equipment 100 is located in a machine-learning assisted area.

Moreover, FIG. 1 illustrates a network entity 200 of the wireless communication system.

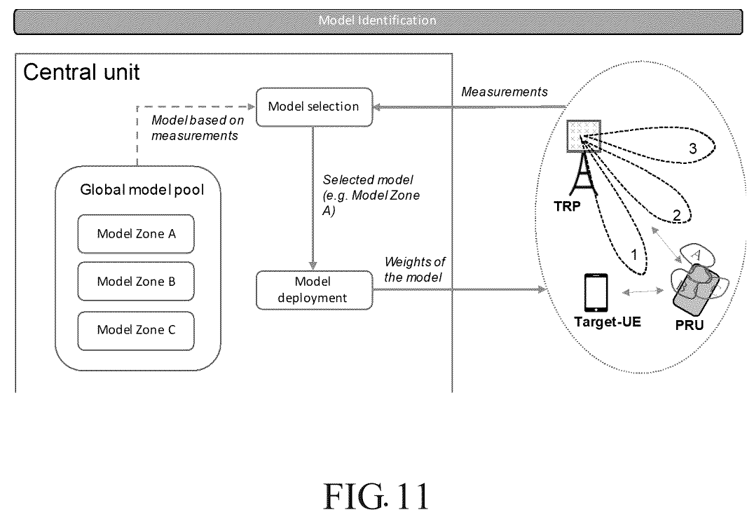

Particular details on machine-learning models and/or machine-learning assisted areas will, e.g., be provided in the description later on, see, for example FIG. 11 to FIG. 17 and the corresponding portions in the description relating to these figures.

Moreover, some embodiments relating to machine-learning models and/or machine-learning assisted areas will now be provided.

According to an embodiment, the user equipment 100 may, e.g., be a sensor unit and/or wherein the user equipment 100 may, e.g., have sensor unit capabilities.

In an embodiment, the user equipment 100 may, e.g., be configured to receive the information that the user equipment 100 is located in a machine-learning assisted area from a network entity 200 of the wireless communication system.

According to an embodiment, the user equipment 100 may, e.g., be configured to receive information from a network node of the wireless communication system comprising information on at least one of the following
that no AI/ML support for the area in which the user equipment 100 is located is provided,
that the model for the area in which the user is located is still in the training phase, and that the model is requesting further data for model training,
that the model is partially trained, and that to further determine the availability of ML/AI support, a position estimate or a distance estimate or a range estimate may be required and/or measurement signal classification,
that the model covers also NLOS areas and is able to determine a position or a distance in NLOS areas also,
that the model is available, but the accuracy may be degraded, for example due to changes in the environment,
a mode of operation, for example a need for update operation mode due to a confidence decrease and/or for example an update phase operation mode and/or for example a high-confidence operation mode in an NLOS area.

In an embodiment, the user equipment 100 may, e.g., be configured to conduct one or more measurements by measuring one or more reference signals. The user equipment 100 may, e.g., be configured to determine whether or not the user equipment 100 is located in a machine-learning assisted area by receiving an indication from the network entity 200 of the wireless communication system, and/or by receiving assistance data required for the identification of a machine-learning assisted area from the network entity 200 of the wireless communication system. And/or, the user equipment 100 may, e.g., be configured to identify the machine-learning assisted area by analyzing the one or more measurements. And/or, the user equipment 100 may, e.g., be configured to transmit information on the one or more measurements to an entity of the wireless communication system and to obtain information on whether or not the user equipment 100 is located in a machine-learning assisted area from said entity or from another entity of the wireless communication system in response to transmitting said information on the one or more measurements.

According to an embodiment, the user equipment 100 may, e.g., be configured to measure the one or more reference signals being one or more downlink reference signals, and/or by one or more sidelink reference signals and/or one or more uplink reference signals.

In an embodiment, said one or more downlink reference signals are one or more of a PSS, a SSS, a CSI-RS and a DL-PRS, and/or wherein the one or more uplink reference signals are one or more UL-PRS and/or one or more SRS.

According to an embodiment, the user equipment 100 may, e.g., be configured to receive one or more thresholds. The user equipment 100 may, e.g., be configured to compare the one or more measurements with the one or more thresholds to determine whether or not the user equipment 100 is located in a machine-learning assisted area.

In an embodiment, the one or more thresholds comprise at least one of an RSRP threshold and an SNR threshold. Depending on the RSRP threshold and/or the SNR threshold, the user equipment 100 may, e.g., be configured to trigger an activation or deactivation of the machine-learning model.

According to an embodiment, the user equipment 100 may, e.g., be configured to conduct one or more of the following measurements
a RSRP (Reference Signal Received Power) on one or more downlink reference signals,
a RSRPP (Reference Signal Received Path Power) on one or more downlink reference signals,
a RSTD,
an AoD,
an AoA,
a RxTx time difference.

The user equipment 100 may, e.g., be configured to report information on said one or more measurements to a network entity 200 of the wireless communication system.

In an embodiment, using the machine-learning model or parameters of the machine-learning model, the user equipment 100 may, e.g., be configured to determine its position and/or to determine a distance between the user equipment 100 and another entity, for example another user equipment 100, of the wireless communication system, for example ranging information.

According to an embodiment, the user equipment 100 may, e.g., be configured to receive the machine-learning model or the parameters of the machine-learning model from a network entity 200 of the wireless communication system.

In an embodiment, the machine-learning model represents a selected machine-learning model selected a from a set of machine-learning models, e.g., from a global pool of machine-learning models.

According to an embodiment, the user equipment 100 may, e.g., be configured to select the machine-learning model from a set of machine-learning models, e.g., from a global pool of machine-learning models.

In an embodiment, the user equipment 100 may, e.g., be configured to receive a description or a configuration comprising the set of machine-learning models.

According to an embodiment, the set of machine-learning models may, e.g., comprise a plurality of machine-learning models, wherein each of the plurality of machine-learning models is a machine-learning model for a particular zone, e.g., for a particular region.

In an embodiment, the user equipment 100 may, e.g., be configured to select the machine-learning model from the set of machine-learning models depending on one or more measurements.

According to an embodiment, a result of the one or more measurements depends on the position of the user equipment 100.

In an embodiment, the user equipment 100 may, e.g., be configured to deploy the machine-learning model or a portion thereof, or the parameters of the machine-learning model or a portion thereof, to other user equipments. And/or, the user equipment 100 may, e.g., be configured to update the machine-learning model or a portion thereof, or the parameters of the machine-learning model or a portion thereof, during an interference phase. And/or, the user equipment 100 may, e.g., be configured to update the machine-learning model or a portion thereof, or the parameters of the machine-learning model or a portion thereof, in a global pool.

According to an embodiment, during a training of the machine-learning model, the user equipment 100 may, e.g., be configured to monitor an output of the machine-learning model.

In an embodiment, the user equipment 100 may, e.g., be configured to train a pre-trained model to obtain a trained model.

According to an embodiment, an input of the machine-learning model may, e.g., be at least one of:
one or more channel impulse response/s,
at least one TOA,
at least one AOA,
at least one AOD,
at least one TOT,
at least one TDOA.

In an embodiment, the user equipment 100 may, e.g., be configured to receive update information on the machine-learning model or on parameters of the machine-learning model from a network entity 200 of the wireless communication system. The user equipment 100 may, e.g., be configured to update the machine-learning model or the parameters of the machine-learning model using the update information.

According to an embodiment, the user equipment 100 may, e.g., be configured to receive training data from another user equipment 100. The user equipment 100 may, e.g., be configured to train and/or to retrain and/or to calibrate a machine-learning model using the training data.

In an embodiment, the user equipment 100 may, e.g., be configured to receive assistance data from a network entity 200 of the wireless communication system, if the user equipment 100 is located in a machine-learning assisted area.

According to an embodiment, the user equipment 100 may, e.g., be configured to receive information from a network entity 200 of the wireless communication system that said assistance data is available, if the user equipment 100 is located in a machine-learning assisted area.

In an embodiment, the user equipment 100 may, e.g., be configured to receive as the assistance data one or more machine-learning model parameters of the following:
a machine-learning model, for example a type of a model,
a structure of the model, for example a type and/or a number of layers and structural dependencies thereof,
one or more features, for example input data, of a machine-learning model,
one or more coefficients describing a machine-learning model and/or a part thereof,
additional assistance data in making measurement,
information to trigger the user equipment 100 to provide additional measurements, for example as sensor unit.

According to an embodiment, the user equipment 100 may, e.g., be configured to receive information from a network node of the wireless communication system comprising information that additional information from the user equipment 100 is requested. The additional information for example may, e.g., comprise information associating the measurement from one positioning session to another positioning session and/or for example coherence between measurements. The user equipment 100 may, e.g., be configured to transmit the additional information.

Moreover, a user equipment 100 of a wireless communication system according to an embodiment is provided. The user equipment 100 is configured to determine if it shall act as a temporal anchor unit, for example as a temporal anchor or as a temporal PRU or as a PRU, depending on the temporal reference information.

According to an embodiment, if the user equipment 100 has determined that it shall act as a temporal anchor unit, the user equipment 100 exhibits information on its position, or another entity, for example a network entity 200, of the wireless communication system may, e.g., comprise information on the position of the user equipment 100 and/or may, e.g., comprise information on a distance between the user equipment 100 and another entity, for example another user equipment 100, of the wireless communication system, for example ranging information.

In an embodiment, if the user equipment 100 has determined that it shall act as a temporal anchor unit, the user equipment 100 may, e.g., be configured to transmit one or more reference signals to another user equipment 100 of the wireless communication system, and/or may, e.g., be configured to receive one or more reference signals from the other user equipment 100, for example to determine position information on a position of the other user equipment 100, and/or to determine information on a distance between the user equipment 100 and another entity, for example another user equipment 100, of the wireless communication system, for example ranging information.

According to an embodiment, if the user equipment 100 has determined that it shall act as a temporal anchor unit, the user equipment 100 may, e.g., be configured to report, in a same positioning session, information on its position, and/or to information on a distance between the user equipment 100 and another entity, for example another user equipment 100, of the wireless communication system, for example ranging information; and information on one or more measurements on a reference signal.

In an embodiment, if the user equipment 100 has determined that it shall act as a temporal anchor unit, the user equipment may, e.g., be configured to receive a position reference signal from an entity of the wireless communication system, and/or the user equipment 100 may, e.g., be configured to transmit a position reference signal to the entity, the entity being a network entity 200 or another user equipment 100 of the wireless communication system.

According to an embodiment, if the user equipment 100 has determined that it shall act as a temporal anchor unit, a network entity 200 of the wireless communication system may, e.g., be able to determine the position of a device of the wireless communication system and/or to determine a distance between the user equipment 100 and the device, by receiving reports on one or more measurements from the user equipment 100, for example one or more measurements performed on a position reference signal transmitted by other devices in the wireless communication system.

In an embodiment, the user equipment 100 may, e.g., be configured to receive a temporal reference information message from a network entity 200 of the wireless communication system or from another user equipment 100 of the wireless communication system. The temporal reference information message may, e.g., comprise the temporal reference information.

According to an embodiment, the user equipment 100 has access to the temporal reference information without receiving the temporal reference information within a message.

In an embodiment, the user equipment 100 may, e.g., be configured to determine and/or to assist determining a position of another user equipment 100 of the wireless communication system.

According to an embodiment, the temporal reference information may, e.g., comprise one or more condition criteria. The user equipment 100 may, e.g., be configured to determine whether or not it shall act as a temporal anchor unit by determining for at least one condition criterion of the one or more condition criteria whether or not the user equipment 100 satisfies said at least one condition criterion.

In an embodiment, the one or more condition criteria comprise one or more of the following:
an indication on the positioning absolute or relative accuracy,
a certainty,
a position quality,
a protection level, which may, e.g., be a statistical upper-bound of the positioning error,
an integrity flagging, which may, e.g., be indication of whether protection level is larger than an alert limit or not.

According to an embodiment, the one or more condition criteria comprise a capability signaling to provide one or more of the following information:
a bearing,
an orientation,
a velocity,
an acceleration,
a motion state within a movement model, for example one of the states stationary, pedestrian, vehicular traffic, highway traffic.

In an embodiment, if the user equipment 100 has determined that it shall act as a temporal anchor unit, the user equipment 100 may, e.g., be configured to provide information that it is to act as a temporal anchor unit using PRU capability signaling to one of the network entities or one of the user equipments (100) of the wireless communication system.

According to an embodiment, if the user equipment 100 has determined that it shall act as a temporal anchor unit, the user equipment 100 may, e.g., be configured to report its position and/or to report one or more measurements and/or to transmit a position reference signal and/or to receive a position reference signal to/from an entity of the wireless communication system within a same positioning session and/or to report information on a distance between the user equipment 100 and another entity, for example another user equipment 100, of the wireless communication system, for example ranging information.

In an embodiment, if the user equipment 100 has determined that it shall act as a temporal anchor unit, the user equipment 100 may, e.g., be configured to provide information to one of the entities of the wireless communication system for a machine-learning model for positioning.

According to an embodiment, if the user equipment 100 has determined that it shall act as a temporal anchor unit, the user equipment 100 may, e.g., be configured to provide ACS information, for example, information on one or more characteristics of one or more transmission channels of the wireless communication system, and/or to provide information on a validity of ACS information for a particular region, to an entity of the wireless communication system.

In an embodiment, if the user equipment 100 has determined that it shall not act as a temporal anchor unit, the user equipment 100 may, e.g., be configured to refrain from reporting its position to an entity of the wireless communication system, and/or may, e.g., be configured to report to an entity of the wireless communication system that it will not act as a temporal anchor unit. And/or, if the user equipment 100 has determined that it shall no longer act as a temporal anchor unit, the user equipment 100 may, e.g., be configured to refrain from reporting its position to an entity of the wireless communication system, and/or may, e.g., be configured to report to an entity of the wireless communication system that it will no longer act as a temporal anchor unit.

According to an embodiment, the user equipment 100 may, e.g., be capable to transmit information on its position, and/or may, e.g., be capable to transmit information on a distance between the user equipment 100 and another entity, for example another user equipment 100, of the wireless communication system, for example ranging information.

In an embodiment, the user equipment 100 may, e.g., be configured to inform the network about its capability to become a temporal anchor unit.

According to an embodiment, if one or more predefined conditions are fulfilled, the user equipment 100 may, e.g., be configured to inform the network that the condition for the UE to act as a PRU is fulfilled, and/or the user equipment 100 may, e.g., be configured to begin to send measurements to a network entity 200 or to another user equipment 100 of the wireless communication system, for example, so that the user equipment 100 acts as a temporal anchor or a PRU.

In an embodiment, the user equipment 100 may, e.g., be configured to acquire its position using a first positioning method, for example a GNSS and/or a iGPS and/or a RAT dependent positioning method, and/or using reference information, for example O&M, and may, e.g., be configured to provide reference measurements and/or to transmit signals for collecting reference measurements to a network entity 200 and/or to another user equipment 100 of the wireless communication system, for example, to fulfil the condition for being a PRU.

According to an embodiment, the user equipment 100 may, e.g., be configured to receive a request, for example from a network entity 200 of the wireless communication system, to act as a temporal anchor unit for another device.

In an embodiment, the user equipment 100 may, e.g., be configured to conduct RTT measurements.

According to an embodiment, the user equipment 100 may, e.g., be configured to conduct one or more measurements for one or more sidelinks with one or more other user equipment 100s of the wireless communication system.

In an embodiment, the one or more measurements measure a sidelink range and/or provide direction information between the user equipment 100 and another user equipment 100 to be located.

According to an embodiment, the user equipment 100 may, e.g., be configured to employ a RAT-independent technology to determine a range and/or direction, and may, e.g., be configured to inform a network entity 200 of the wireless communication system or another device that the ranging and/or directional information is obtained using a RAT-independent technology.

In an embodiment, the user equipment 100 may, e.g., be configured to employ one or more of the following ranging technologies as the RAT-independent technology:
UWB,
Lidar,
Radar,
a WLAN based ranging.

Furthermore, a user equipment 100 of a wireless communication system according to an embodiment is provided. The user equipment 100 is configured to obtain information on its position and/or to obtain information on a distance between the user equipment 100 and another entity, for example another user equipment 100, of the wireless communication system, for example ranging information. The information is obtained by receiving, for example via a direct communication link or indirectly through the network, information from another user equipment 100 which acts as a temporal anchor unit, for example a temporal anchor or a temporal PRU or a PRU, wherein said information received from the temporal anchor unit comprises a position of the temporal anchor unit and/or one or more measurements performed by the temporal anchor unit on signals transmitted by the user equipment 100, or wherein said information comprises a position reference signal. Moreover, the information is obtained by performing one or more measurements on one or more received signals, and/or by transmitting to a network entity 200, for example to a LMF or to a NWDAF, derived information derived from said measurements of the wireless communication system.

According to an embodiment, the user equipment 100 may, e.g., be configured to determine its position itself, for example by employing user equipment based OTDOA, and/or may, e.g., be configured to report its position to a network entity 200 of the wireless communication system. The user equipment 100 may, e.g., be configured to perform and/or to report one or more measurements on the one or more received signals, being one or more downlink signals.

Moreover, a user equipment 100 of a wireless communication system according to an embodiment is provided. The user equipment 100, for example being an UL-TDOA device, is configured to support an entity, for example a network entity 200, of the wireless communication system to obtain information on a position of the user equipment 100 and/or to obtain information on a distance between the user equipment 100 and another entity, for example another user equipment 100, of the wireless communication system, for example ranging information, by transmitting, for example via a direct communication link or indirectly through the network, one or more reference signals to a another user equipment 100 which acts as a temporal anchor unit, for example a temporal anchor or a temporal PRU or a PRU, to allow the temporal anchor to conduct one or more measurements on the one or more reference signals and/or to report the one or more measurements to said entity of the wireless communication system.

Furthermore, a user equipment 100 of a wireless communication system according to an embodiment is provided. The user equipment 100 is configured to determine, for example by using a RAT-independent technology and/or by using a RAT-dependent technology and/or by using a temporal anchor, or is configured to receive, information on its position, and/or information on a distance between the user equipment 100 and another entity, for example another user equipment 100, of the wireless communication system, for example ranging information. Moreover, the user equipment 100 is configured to assist in generating training data for a machine-learning model for positioning using the information on its position and/or the information on said distance, for example for machine learning with related labels.

For example wherein the machine-learning model may, e.g., be located on an LMF or on a NWDAF of the wireless communication system.

According to an embodiment, the user equipment 100 may, e.g., be configured to employ information on one or more channel impulse responses to assist in generating training data for the machine-learning model.

In an embodiment, the user equipment 100 may, e.g., be configured to transmit information one the one or more channel impulse responses and information on its position and/or on said distance to an entity, for example a network entity 200, of the wireless communication system to assist in generating training data for the machine-learning model.

Moreover, a user equipment 100 of a wireless communication system according to an embodiment is provided.

The user equipment 100 is configured to transmit information on one or more properties of RF channel characteristics between the user equipment 100 and another entity of the wireless communication system and/or an indicator on the probability that a direct path (“line-of-sight” path) exists and/or information on the characteristics of one or more RF channel propagation paths not related to the direct path, wherein the other entity of the wireless communication system is a base station or is another user equipment 100 of the wireless communication system.

Furthermore, the user equipment 100 is configured to report, to said other entity or to a further entity of the wireless communication system, information on one or more channel impulse responses.

According to an embodiment, the user equipment 100 may, e.g., be configured to report to a network entity 200 of the wireless communication system one or more signal characteristics of at least one received reference signal comprising at least one of the following information
a signal strength,
a LOS/NLOS probability,
an information on one or more received beams,
a similarity of two or more, for example consecutive, beams,
one or more channel impulse response parameters,
a similarity of two or more, for example consecutive, channel impulse responses,
one or more estimates on a distance and/or an orientation,
a motion profile,
a signal classification, for example depending on confidence information.

In an embodiment, the user equipment 100 may, e.g., be configured to employ a measurement on a DL-reference signal during conducting or supporting an execution of a DL-TDOA, and/or a multi-RTT and/or a DL-AoD method.

According to an embodiment, if a number of TRPs with LOS conditions are not sufficient, the user equipment 100 may, e.g., be configured to indicate to a network entity 200 of the wireless communication system that the number of TRPs with LOS conditions are not sufficient.

In an embodiment, the user equipment 100 may, e.g., be configured to receive information from an entity of the wireless communication system to communication with another user equipment 100 that acts as a temporal anchor unit, for example, as a temporal anchor or as a temporal PRU or as a PRU, to obtain information on its position, and/or to obtain information on a distance between the user equipment 100 and another entity, for example another user equipment 100, of the wireless communication system, for example ranging information.

According to an embodiment, the user equipment 100 may, e.g., be a sensor unit and/or wherein the user equipment 100 has sensor unit capabilities.

In an embodiment, said other user equipment 100 which acts as a temporal anchor unit may, e.g., be a user equipment 100 as described above.

According to an embodiment, the user equipment 100 may, e.g., be configured to receive and process information on one or more available temporal anchor units.

In an embodiment, the user equipment 100 may, e.g., be configured to transmit a PRS signal synchronized to a network entity 200 of the wireless communication system to another entity, for example a sidelink PRS to another user equipment 100, of the wireless communication system.

According to an embodiment, the user equipment 100 may, e.g., be configured to measure a time of arrival on SRS signals relative to a network clock of the wireless communication system.

In an embodiment, the user equipment 100 may, e.g., be configured as a user equipment 100 as described above.

According to an embodiment, the user equipment 100 may, e.g., be configured to receive a machine-learning model or parameters of the machine-learning model from a network entity 200 of the wireless communication system. The user equipment 100 may, e.g., be configured to determine its position using the machine-learning model or the parameters of the machine-learning mode, and/or wherein the user equipment 100 may, e.g., be configured to determine a distance between the user equipment 100 and another entity, for example another user equipment 100, of the wireless communication system, for example ranging information.

In an embodiment, the user equipment 100 may, e.g., be configured to receive update information on the machine-learning model or on parameters of the machine-learning model from a network entity 200 of the wireless communication system. The user equipment 100 may, e.g., be configured to update the machine-learning model or the parameters of the machine-learning model using the update information.

According to an embodiment, the user equipment 100 may, e.g., be configured to receive training data from another user equipment 100. The user equipment 100 may, e.g., be configured to train and/or to retrain and/or to calibrate a machine-learning model using the training data.

In an embodiment, the user equipment 100 may, e.g., be configured to report its position and/or to report one or more measurements and/or to transmit a position reference signal and/or to receive a position reference signal to/from another user equipment of the wireless communication system via a sidelink and/or to report information on a distance between the user equipment 100 and another entity, for example another user equipment, of the wireless communication system, for example ranging information.

According to an embodiment, the user equipment 100 may, e.g., be configured to transmit training data to a network entity 200 of the wireless communication system to train and/or to retrain and/or to calibrate a machine-learning model.

In an embodiment, the user equipment 100 may, e.g., be configured to transmit training data to another user equipment of the wireless communication system to train and/or to retrain and/or to calibrate a machine-learning model.

Furthermore, a user equipment 100 of a wireless communication system is provided.

The user equipment 100 is configured to receive measurement and/or transmission characteristics information.

According to an embodiment, the user equipment 100 may, e.g., comprise and/or implements a measurement device, and may, e.g., be configured to receive measurement and/or transmission characteristics information, which enables the measurement device to identify one or more measurement characteristics.

In an embodiment, the user equipment 100 may, e.g., comprise and/or implements a transmission device, and may, e.g., be configured to transmit a PRS, which enables the network to identify and/or to generate training data for model calibration.

According to an embodiment, the measurement and/or transmission characteristics information may, e.g., be associated with one or more TRPs and may, e.g., be further associated with a geographical region.

In an embodiment, the measurement and/or transmission characteristics information may, e.g., be ACS information (Association and Calibration Spots information).

According to an embodiment, the ACS information may, e.g., be associated with one or more TRPs and may, e.g., be further associated with a geographical region.

In an embodiment, the user equipment 100 may, e.g., be configured to determine for the measurement and/or transmission characteristics information, whether the measurement and/or transmission characteristics information is valid for the region in which the user equipment 100 is located.

According to an embodiment, the user equipment 100 may, e.g., be configured to conduct and/or to report one or measurements of one or more reference signals depending on the measurement and/or transmission characteristics information.

In an embodiment, the user equipment 100 may, e.g., be configured to receive the measurement and/or transmission characteristics information comprising power information on a power level of a given path, for example wherein the power information is absolute or is relative with respect to one or more resources or multiple paths within a resource or within a measurement. The user equipment 100 may, e.g., be configured to use this information to detect the indicated path and/or to determine its position and/or to report measurements related to the detected path; and/or to determine information on a distance between the user equipment 100 and another entity, for example another user equipment, of the wireless communication system, for example ranging information.

According to an embodiment, the user equipment 100 may, e.g., be configured to use the measurement and/or transmission characteristics information to set a detection method or a detection threshold to derive a ToA and/or a RSRPP and/or an AoA.

In an embodiment, the measurement and/or transmission characteristics information may, e.g., comprise at least one indication on a delay and/or a direction of a non-LOS path.

According to an embodiment, the measurement and/or transmission characteristics information may, e.g., comprise at least one indication on a plurality of beams detectable in a region, e.g., an ACS region.

In an embodiment, the plurality of beams are associated with one or more expected channel conditions which comprise one or more of the following:
a soft or a hard value indication for LOS or NLOS conditions per beam,
an expected Power level per each beam, for example RSRPP and/or RSRP.

According to an embodiment, the plurality of beams are associated with an indicated antenna radiation information of the main, null or side lobes provided to the user equipment 100.

In an embodiment, the user equipment 100 may, e.g., be configured to receive information on two or more antennas of a same TRP of the wireless communication system and/or on two or more antennas of a same user equipment 100 of the wireless communication system.

Moreover, a user equipment 100 of a wireless communication system according to an embodiment is provided.

The user equipment 100 is configured to receive from a network entity 200 of the wireless communication system one or more PRS configurations for one or more antennas of one or more transmitting devices of the wireless communication system.

Moreover, the user equipment 100 is configured to receive from a network entity 200 of the wireless communication system measurement and/or transmission characteristics information comprising a set of one or more parameters.

Furthermore, the user equipment 100 is configured to determine, using the one or more PRS configurations and using the measurement and/or transmission characteristics information, its position and/or information on a distance between the user equipment 100 and another entity, for example another user equipment, of the wireless communication system, for example ranging information.

According to an embodiment, the user equipment 100 may, e.g., comprise and/or implements a measurement device, and may, e.g., be configured to receive measurement and/or transmission characteristics information, which enables the measurement device to identify one or more measurement characteristics.

In an embodiment, the measurement and/or transmission characteristics information may, e.g., be ACS information (Association and Calibration Spots information).

According to an embodiment, the user equipment 100 may, e.g., be configured to select a portion of the measurement and/or transmission characteristics information as a subset of the measurement and/or transmission characteristics information.

In an embodiment, the user equipment 100 may, e.g., be configured to select the subset of the measurement and/or transmission characteristics information depending on information received from a network entity 200 of the wireless communication system and/or depending on information derived from a sidelink and/or depending on information derived from an uplink reference signal and/or depending on movement type or velocity information or orientation information or pressure information.

According to an embodiment, the user equipment 100 may, e.g., be configured to receive a first portion of the measurement and/or transmission characteristics information. The user equipment 100 may, e.g., be configured to receive a second portion of the measurement and/or transmission characteristics information after the first portion, wherein the second portion may, e.g., comprise more detailed information than the first portion.

In an embodiment, the measurement and/or transmission characteristics information may, e.g., comprise one or more of the following:
one or more delay paths for the LOS and/or multipath components,
one or more directional paths LOS and/or multipath components,
power/Magnitude information for one or more directional and delay path associated with one resource or one path per resource,
expected LOS delay and magnitude to a multipath component such as the maximum peak expected by a given resource,
window configuration indicating the expected delay or direction of the LOS or multipath to be applied on the measurements or to be reported,
window configuration indicating the expected delay or direction of the LOS or multipath not to be applied on the measurements or to be reported,
a validity region with information on the validity where the information can be soft or hard values,
correlation of measurement and/or transmission characteristics information in a given area and number of updates measurement and/or transmission characteristics information needed or expected,
an indication from a measurement unit.

According to an embodiment, the user equipment 100 may, e.g., be a sensor unit and/or wherein the user equipment 100 has sensor unit capabilities.

Moreover, a network entity 200 of a wireless communication system according to an embodiment is provided. The network entity 200 is configured to transmit to a user equipment 100 of the wireless communication system temporal reference information for enabling the user equipment 100 to determine if it is able to act as a temporal anchor unit, for example as a temporal anchor or as a temporal PRU or as a PRU. If the user equipment 100 has determined that it shall act as a temporal anchor unit, the network entity 200 is configured to receive from the user equipment 100 information on its position and/or on one or more measurements and/or on a position reference signal; and/or on a distance between the user equipment 100 and another entity, for example another user equipment 100, of the wireless communication system, for example ranging information.

Furthermore, a network entity 200 of a wireless communication system according to an embodiment is provided. The network entity 200 is configured to receive information from a user equipment 100 of the wireless communication system on one or more line-of-sight links, for example defined by that an RF channel including a direct path with a delay according to the distance, or on one or more properties or one or more characteristics of one or more RF channels between network entities or a non-presence of a line-of-sight links to another entity, for example to another network entity 200, of the wireless communication system.

According to an embodiment, the network entity 200 may, e.g., be configured to transmit information that a user equipment 100 of the wireless communication system is located in a machine-learning assisted area.

In an embodiment, the network entity 200 may, e.g., be configured to store one or more identifiers of a user equipment 100 of the wireless communication system which is entering a machine-learning-assisted area. The network entity 200 may, e.g., be configured to deleting the identifier of the user equipment 100 leaving the machine-learning-assisted area. Moreover, the network entity 200 or another entity of the wireless communication system may, e.g., be configured to obtain the identifier of at least one user equipment 100 located inside the machine-learning-assisted area to initiate procedures to train a machine-learning model and/or to update the machine-learning model.

According to an embodiment, the network entity 200 may, e.g., be configured to transmit a machine-learning model or parameters of the machine-learning model to the user equipment 100.

In an embodiment, the network entity 200 may, e.g., be configured to receive training data from the user equipment 100. The network entity 200 may, e.g., be configured to train and/or to retrain and/or to calibrate a machine-learning model using the training data.

Moreover, a network entity 200 of a wireless communication system according to an embodiment is provided. If a user equipment 100 of the wireless communication system shall act as a temporal anchor unit. The network entity 200 is configured to receive information on one or more measurements from the user equipment 100, for example one or more measurements performed on a position reference signal transmitted by the device. Moreover, the network entity 200 is configured to determine a position of the device and/or to determine a distance between the user equipment 100 and the device, using information on a position of the user equipment 100 and using the information on the one or more measurements.

Furthermore, a network entity 200 of a wireless communication system according to an embodiment is provided. The network entity 200 is configured to transmit measurement and/or transmission characteristics information, for example, ACS information (Association and Calibration Spots information), to a user equipment 100 of the wireless communication system, wherein the measurement and/or transmission characteristics information is associated with one or more TRPs and is further associated with a geographical region.

Moreover, a network entity 200 of a wireless communication system according to an embodiment is provided. The network entity 200 is configured to transmit to a user equipment 100 of the wireless communication system one or more PRS configurations for one or more antennas of one or more transmitting devices of the wireless communication system. The network entity 200 is configured to transmit to the user equipment 100 of the wireless communication system measurement and/or transmission characteristics information, for example, ACS information (Association and Calibration Spots information), comprising a set of one or more parameters, for example wherein the measurement and/or transmission characteristics information comprises information on the relationship between an ACS-ID and assistance data, for example wherein the assistance data comprises a PRS configuration.

According to an embodiment, the NW entity may, e.g., be any one of the following:
a NWDAF,
a LMF,
a NRF,
a NEF,
a NG-RAN,
an AMF,
a GMLC,
a UDM.

Moreover, a wireless communication system, comprising one or more user equipments (100) as described above one or more network entities as described above according to embodiments is provided.

Furthermore, a wireless communication system according to an embodiment is provided. The wireless communication system comprises at least two entities, wherein each of the at least two entities is a user equipment 100 or is a network entity 200, wherein the at least two entities comprise a first entity and a second entity. The first entity is configured to determine, if it shall act as a temporal anchor unit, for example as a temporal anchor or as a temporal PRU or as a PRU, depending on temporal reference information. The second network entity 200 is configured to perform one or more measurements and is configured to provide one or more reports derived from the one or more measurements to a another network entity 200, for example to an LMF or to an NWDAF, to train a model, for example neural network, or to capture the characteristics of one or more RF signals received in an area.

According to an embodiment, the first entity, for example a temporal anchor, may, e.g., be configured to transmit and/or may, e.g., be configured to receive one or more reference signals to/from the second entity as information. The second entity may, e.g., be configured to employ this information to determine its position; and/or to determine information on a distance between the second entity and another entity, for example another user equipment, of the wireless communication system, for example ranging information.

In an embodiment, the first entity, for example a temporal anchor, may, e.g., be configured to provide information on the one or more measurements performed on the one or more reference signals received, and/or may, e.g., be configured to report the characteristics of the one or more reference signals received to the second entity as information. The second entity may, e.g., be configured to employ this information to determine its position relative to the first entity; and/or to determine a distance between the second entity and the first entity, for example ranging information.

According to an embodiment, the first entity may, e.g., be a user equipment 100 as described above and the second entity may, e.g., be a network entity 200 as described above. Or, the second entity may, e.g., be a user equipment 100 as described above and the first entity may, e.g., be a network entity 200 as described above.

Furthermore, a wireless communication system according to an embodiment is provided. At least one of the plurality of entities is configured to use one or more measurements of one or more user equipments (100) of the wireless communication system for conducting one or more comparisons. Moreover, at least one of the plurality of entities is configured to conduct unsupervised learning of similar properties or characteristics, for example of one or more channel impulse responses or one or more parameters thereof. At least one of the plurality of entities is configured to employ one or more temporal anchors of the wireless communication system are used for supervised learning. Furthermore, at least one of the plurality of entities is configured to conduct supervised learning for mapping similar properties or characteristics, for example of a channel impulse responses or of parameters thereof, to corresponding reference information, for example to a velocity and/or to an orientation and/or to an acceleration and/or to a position and/or to a distance. At least one of the plurality of entities is configured to train or to collect a ML-model using a combination of supervised, for example with output labels, and unsupervised, for example without output labels, approaches. Furthermore, at least one of the plurality of entities is configured to employ labels that are obtained from one or more temporal anchors are to provide real world dimensions to the trained model, wherein the labels allow to transform, for example to scale and to rotate, the learned representation to a real-world dimension.

According to an embodiment, the plurality of entities may, e.g., comprise a user equipment 100 as described above and a network entity 200 as described above.

In the following, particular embodiments of the present invention are described.

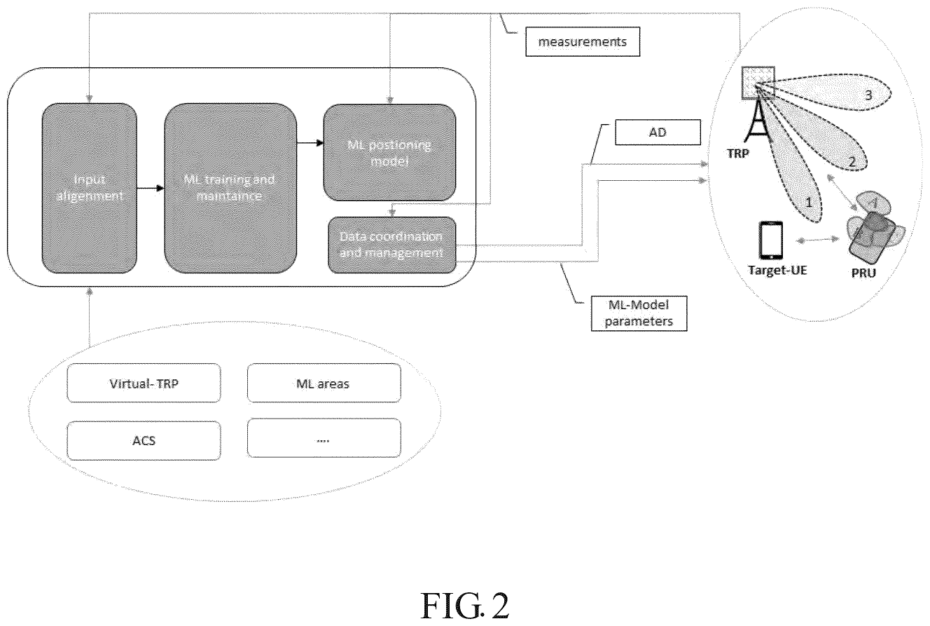

FIG. 2 illustrates an overview of some of the concepts according to particular embodiments.

Embodiments may, e.g., comprise utilizing the measurements made by UEs and network entities to learn about the environment, and utilize the information learned to improve the estimate of UE position in LMF-based (UE-assisted and TRP-assisted) or UE-based modes.

The goal of the solution is to provide complementary information to a positioning algorithm useful as reference for the position calculation. This may enable signals transmitted or received under NLOS-condition to/from the TRPs to be useful for positioning. Examples are (1) Virtual TRP and (2) CIR and directional characteristic.

Regarding “Virtual TRP”, walls, ceiling or other objects may act as “mirror” for signals. If the position of the mirror is known, a signal received as reflection from this mirror can be used by positioning algorithms.

Regarding “CIR and directional characteristic”, even if the positions of the reflecting objects are not identified, the CIR may include information which can be used if the bouncing characteristics at a certain position is determinable by the training model without necessarily knowing the Virtual-TRP position. Especially if several TRPs are used, the combination of CIRs and/or directional information may provide a unique (local) fingerprint for each position.

To enable the use of such information the association between the measured data and the position is established. AI/ML based positioning technologies may use this association to train a neural network, for example.

Without limiting the approach to AI/ML based positioning technologies, AI/ML based solutions require a training phase. The training can be spilt into an initial training and continuous update of neural networks (“model”) or any other (parameterized) function approximator for positioning applications.

The proposed solution may, e.g., comprise:
An initial training during the (first) deployment of the system may be applied first. Different methods for initial training may be used. An example are robots scanning the environment.
A continuous update of the neural network by identifying temporal available anchors.
An identification of “virtual TRPs”.
An exchange of information with devices in the same area.

In the following, an example scenario is described.

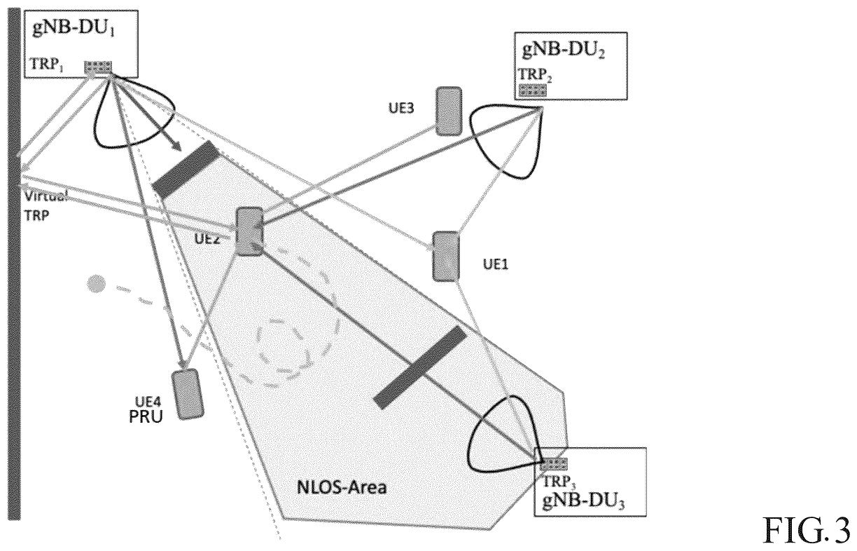

We consider the example scenario in FIG. 3 with the target to position UE2 in heavy NLOS conditions. In the scenario, we have multiple UEs at different positions resulting in different channel conditions w.r.t. the TRPs: UE1, UE3, and UE4 having sufficient number of LOS links, UE2 partly blocked TRP with the possibility to communicate with other UEs. Three examples for other UEs are given:
UE1 may not support the direct communication with other UEs.
UE3 may support distance measurements to other UEs. But the UE may be close to TRP2 and may provide no or minor gain for the calculation of the position of UE2.
UE4 may be well suited as temporal anchor.

If the temporal anchor is available the UE2 can determine its position and can capture related CIR characteristics as “fingerprint”. Any multipath components may be useful as fingerprint. But it should be noted that some CIR components may suffer more from changes in the environment than others.

As an example, we highlight a reflecting object (e.g.: a wall) at fixed position as “Virtual-TRP”. If the position of the reflecting object is known it may be possible to identify it a “virtual TRP” and the CIR resulting from reflections at this object can be predicted for other UE positions also. In some cases, further information on the Virtual-TRPs characteristics such as size of the object (e.g., length of the wall), reflection characteristics (e.g., kind of surface) to further extrapolate the useability of the virtual TRP may be relevant.

FIG. 3 illustrates an example for NLOS positioning.

In the example scenario we used “temporal anchors” and “(temporal) sensors”, for example, with the following characteristics:

A UE (in the example UE4) can become a “temporal anchor” supporting the localization other UEs (in the example UE2), if the UE2 is in a location where the position can't be determined with sufficient accuracy due to the lack of available LOS signals.

If UE2 can be localized with support of the “temporal anchor” the UE can act as “sensor” measuring the characteristics of the received signal and makes the data useful as training data for ML based solutioning (neural network or other embodiments of “fingerprinting” concepts. The measurements (=input data for the ML model=“features”) together with the position (“labels”) form a set of training data.

In principle any UE, for which the position is known (either by RAT dependent or by RAT independent methods) can acts as sensor for training of the model. But typically the training is especially required where other positioning methods fail. Hence, the introduction of “temporal anchors” increase the probability that the position of a UE can be also determined—either by the UE itself (UE-based positioning) or by the network-in critical scenarios.

If the position of the temporal anchor can't be estimated with an accuracy sufficient for RTT or TDOA and/or angle based positioning technogies, the temporal anchor may perform the same measurement as the “sensor-UE” (UE2 in the example) an can provide information on the characteristics of the received signal. This information can be provided to other UEs and compared with data measured by the other UEs to identify commonalities.

Especially if several temporal anchors (at different positions around the “sensor-UE”) provide measurements it may be possible to estimate the position of the sensor-UE by methods able to interpolate between the measurements performed for different positions.

In summary the invention target methods making devices (UEs or other network entities) capable to act—at least temporal—as a sensor providing training data for a AI/ML based positioning methods. This helps to setup and/or fine-tune and/or check the validity of a model for AI/ML based positioning methods.

In the following, the solution details of particular embodiments will be presented. At first, solution elements which play an elementary part in enabling the above procedures will be introduced.

Now, a description of concepts according to some embodiments is provided.

At first, the initial training (first setup of the model) according to embodiments is described.

At least three methods are considered for initial training:
Training is performed with devices which determine its position by other technologies. For example, robots measure the relationship between position and the channel characteristics.
If the setup supports also positioning solutions without neural networks, the training of the model can be performed determining the position for training purpose (“labels”) of the device by this method. Positioning methods relying on LOS links may be not able to provide labels for all locations. Hence, in a first step, the training is performed for areas with sufficient number of LOS links and the position may be calculated using traditional positioning algorithms. This can be also used to establish a “partial trained model” (=model trained for parts of the area only=model trained for areas where the LMF or UE is able to calculate the position without support from a the AI/ML model. During this phase additional information associated to the position is captured, to allow a positioning also in cases when LOS links are lost.
The initial training is performed using data generated offline in simulation. The simulation may take into account known environmental information or emulation from tools like ray-tracing. The initial training may be performed using data generated by simulation.

The methods may be combined. For example, a first pre-training step is performed using data generated in simulation and measurements support the fine-tuning of the model.

Generally, the initial training is left to NW implementation. In one aspect, the NW can provide a device such a UE or TRP with initial training data which the device can make use of to train its model.

Now an update of the model using “temporal anchors” according to embodiments is described.

For the initial training we assumed training devices capable of determining its absolute or relative position by methods not available for devices used in the operational phase. In principle each device, with known position can provide input data for training. But for areas where due to changes in the environment an update of the model is required the device may be no longer able to determine its position. Hence, especially for areas where an update is required, the devices may be not able to locate itself. Looking for other devices temporal available with known position (“temporal anchors”) may solve this issue. If the device can determine its position, it is able to report the association between the position and measured data.
Each device (stationary or moving) with known position can act as anchor for positioning.
The device may, e.g., provide a position quality or uncertainty information or satisfy a condition on the positioning accuracy to be used as an anchor.
A first device may perform distance and/or angular measurements to a second device.
If position of the first devices is known and the second devices cannot detect a sufficient number of anchors using the fixed TRPs it may use the first device as temporal anchor.

Now, an identification of complementary “virtual anchors” is described.

Virtual anchors may, e.g., be characterized by
The signal is transmitted or received by a TRP with known position.
The direct link between the TRP and the UE is blocked or very weak.
The signal is received through a reflector.
The position of the reflector may be known or unknown.
The reflection point is not fixed and may depend on the position of the TRP and the UE. This may be caused from the effect that the incidence angle is equal to the emergent angle, and hence, reflection point depends on the position of the device.

The CIR may include two types of multipath components:
Multipath components related to the known position of a reflector (single bounce reflection) or several reflectors (N-bounce reflection)
Other multipath components

If the multipath component in the measured CIR can be associated with a known position of a reflector the characteristics of CIR can be predicted for other positions. Furthermore, it may be even possible to take into account the position of the reflector for the calculation of the distance. In this case the measured ToA of the multipath component provides similar information as the ToA measured for components received via a direct path from a TRP. Therefore, these signals are associated to “virtual TRPs”. Virtual TRP may help to reduce the number required TRPs or to make TRPs not received under LOS conditions still useful.

In embodiments, we consider that during the training phase with sufficient LOS links the complementary virtual anchors may be identified. If, due to changes in the environment, the number of LOS links is no longer sufficient the “virtual anchors” may help to calculate the position. The UEs, TRPs, and others may also represent nodes of a graph with confidence values for each positions thereof; virtual nodes may be (adversarial) generated between nodes with high confidence; such virtual nodes may be used to solve connections between nodes with low confidence; such a graph may be embedded in a neural network or function approximator; such a graph may also contain time information; such a graph may also be embedded in a neural network; so that the function approximator learns the dynamics of environments (time-dependencies) in its manifold.

Now, an association with neighbors according to embodiments is described. In particular, UEs in the same ACS or similar ACS characteristics are described.

In the following we describe association with neighbors mainly for the DL signal. The same concept can be applied to uplink. In this case the UE transmits and the network evaluates the signal.

If the UE measures a DL reference signal and the association to the position is known the UE can determine its position or can report the measurements to the network for position calculation in the network. The following types of problems may occur:

Due to changes in the environment the association may be no longer valid.

The UE (or the network) does not have reference data for the position (the position was not captured during the training phase, for example).

To solve these issues the UE can exchange (directly or via the network) information with other UEs in the same area

A use of the fingerprint of UEs with known position in the same area as a UE with unknown position may help to estimate the position or to increase the position estimation accuracy

In a first step, UEs with known position close to the UE with unknown position may, e.g., be identified.

By comparing the characteristics of the measurements by a first UE with unknown position with the measurements by other UEs with known position the position of the first UE can be estimated.

For model monitoring, a UE with a known position (example ground truth label) can provide the model management entity or LCM with measurements or triggered for a transmission. The LCM or model inference training/entity will use this measurement to validate the ML model for UEs in the vicinity of the reported measurements of transmission.

The input data for the model training may include information derived from the geometry (position of the TRPs, position of walls, etc.) and data captured by measurements (ACS directional and/or delay information). Changes of the environment may be caused by changes of the position of objects (machines, furniture, moving objects like a car or people, etc.). The model may identify the remaining elements in the input data (“measurements”) not affected by the changes or may be continuously updating by using the information derived from temporal anchors, for example.

Accordingly in one aspect, the NW identifies one or more UEs in an ML supported area. In UE-Assisted mode. the NW configures the UEs or/and the TRPs with a report configuration for the measurements on the DL and/or UL reference signals. The report configuration is associated with one or more DL resource and/or UL resources and includes the directional and/or delay information for the additional paths identified by each. In an optional step, the NW can trigger the one or more UEs to perform and report sidelink measurements. The NW uses this measurement report to identify at least one UE relative position w.r.t other UEs or/and absolute position.

Now, a 5G architecture overview according to embodiments is provided.

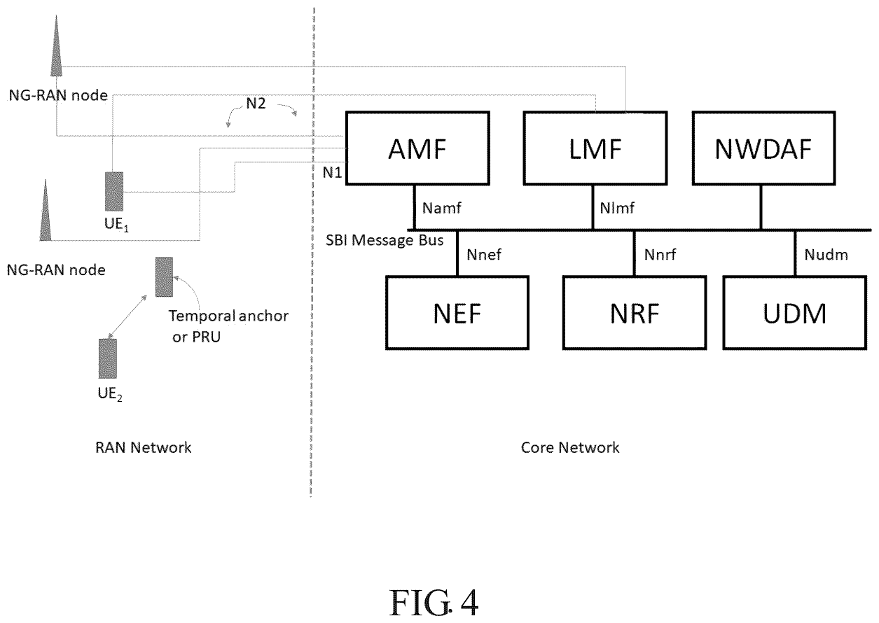

FIG. 4 illustrates some of the important components of a 3GPP network in a non-roaming scenario applicable to positioning. A service based interface representation of the network is shown here, where each components of the 5GS announce their interfaces via a common signalling bus. The 5GS contains more components than described here and are omitted for the purpose of describing the functionality only. The NG-RAN node may host one or more transmission and reception points (TRPs), which may among others-receive SRS transmitted by the UE and/or transmit downlink PRS. At least one NG-RAN node acts as a serving gNB for a UE. The UE registers itself with the access and mobility function (AMF) located in the core network. The signalling between the UE and the AMF is routed through the NG-RAN node.

The LMF is the location management function (LMF) which coordinates the location functionality. Among others, it interacts with the UE and the NG-RAN nodes to compute a position for a UE. To do so, it receives request to localise a UE, coming from the UE (mobile originated location request (MO-LR), coming from the AMF (network induced location request—NI-LR) or coming from another application function or external client—also called mobile terminated location request (MT-LR). To compute the position, the LMF may acquire UE capabilities, and may interact with one or more nodes in RAN-network or core-network to compute the position and to deliver the position to the network client.

The network data analytics function (NWDAF) is the functionality implementing the Nnwdaf interface. This is an example node, which in some deployments, may process the data for training the model and/or compute position based on the data (or features) provided to it by the LMF. Alternatively, in some deployments the computing of the model may take place in LMF itself. Likewise, the trained model may be stored in any one of the network nodes, LMF, NWDAF, NEF, NRF or UDM. The NEF provides the exposure of network functionality to other network functions or external functions or clients. The NRM serves to handle stored data, which may be stored in NRM itself or in a dedicated functionality to store data, called the UDM.

The data may be read and/or stored by NWDAF and/or LMF into one or more of the components. In general, the LMF serves to provide mechanisms to collect data, which may be further processed by itself or provided to the NWDAF for further processing. This is applicable both to training data, validation data and test data.

The model is trained at one of the network entity, either at a LMF or at a NWDAF or partially at LMF and partially at NWDAF. We distinguish four types of training:
1. The methods used for the (initial) training is not defined by the framework and many be vendor or operator specific.
2. The network supports (initial) training generating “labels” using other methods. In case of positioning the LMF or the UE (for UE-based positioning) may calculate the position and provides this to the training entity.
3. Fine-tuning of the model: The initial trained model may be already sufficient to provide valid outputs (in case of positioning the position and/or other data like velocity or driving direction). But further training data may improve the performance.
4. Incremental update of the model to capture changes in the environment or further fine-tuning.

The model training status may be different for each area and may be associated to the ACS data.

The trained model may be obtained either by querying a NWDAF function and/or the NRF and/or the NEF and/or the UDM.

A UE position is determined at the NW side (UE-assisted/NG-RAN assisted mode).

In the following, a first variant is described, where the ML model is trained at the NWDAF:
The model may be trained at the NWDAF using the measurements provided by the LMF. The LMF may provide
   certain information (e.g. list of nearby cells, list of ACS, list of information regarding the environment)
and/or
   one or more measurements made by the UE and/or the LMF
Either
   The LMF queries the NWDAF for position and provides the features used for training model.
   The LMF provides a location parameters (e.g. position, velocity, time, etc.) back to the UE.
Or
   The LMF provides the LMF the parameters of the trained model applicable to a certain area. The area may be indicated by the LMF to the NWDAF.

In the following, a second variant is presented, where ML-model is trained at the LMF:

The UE position is determined at the UE side (UE-based mode)

The ML-model is trained at the NW side, using measurements from one or more UE and/or simulated data. One or more models may be trained at the NW side for a given set of data. There may be one or more models generated and provided by the network subject to UE capability. The UE-capability is related to
The measurements the UE can deliver
The RAT-dependent and RAT-independent technologies supported by the UE
Frequency bands
Bandwidth
The ML-model is provided to the UE subject to UE capability.

UE computes position using the provided assistance data, obtained side information and UE measurements.

UE position is determined at the NW side (UE-assisted/NG-RAN assisted mode).

The ML-model is trained at the NW side, using measurements from one or more UE and/or simulated data. One or more models may be trained at the NW side for a given set of data.

There may be one or more models generated and provided by the network subject to UE capability. The UE-capability is related to
The measurements the UE can deliver
The RAT-dependent and RAT-independent technologies supported by the UE
Frequency bands
Bandwidth

The LMF either obtains the measurements from one or more positioning sessions configured by the UE, and uses this data for training the model.

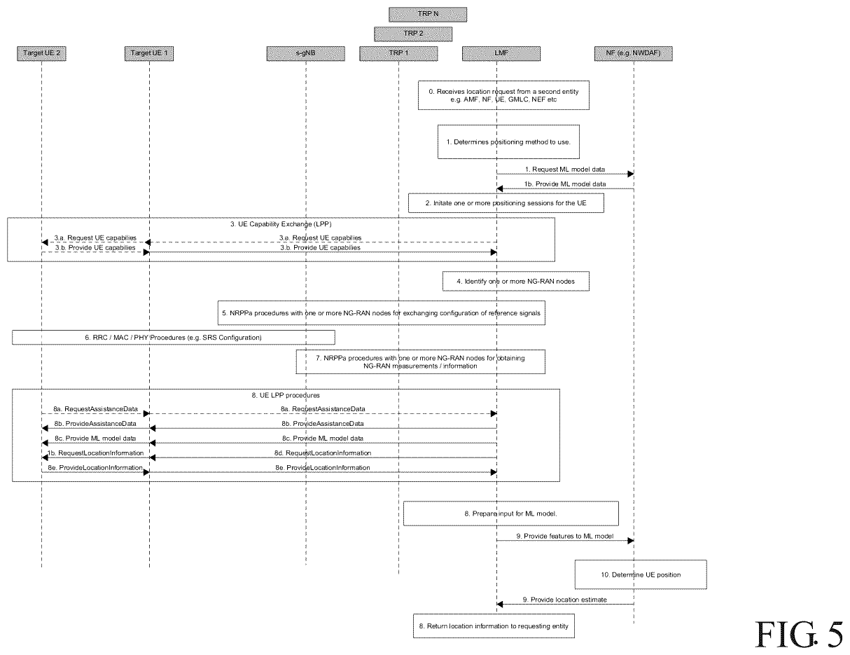

Regarding the procedures, FIG. 5 illustrates an example stage 2 procedure to determine UE position at LMF based on ML model according to an embodiment.

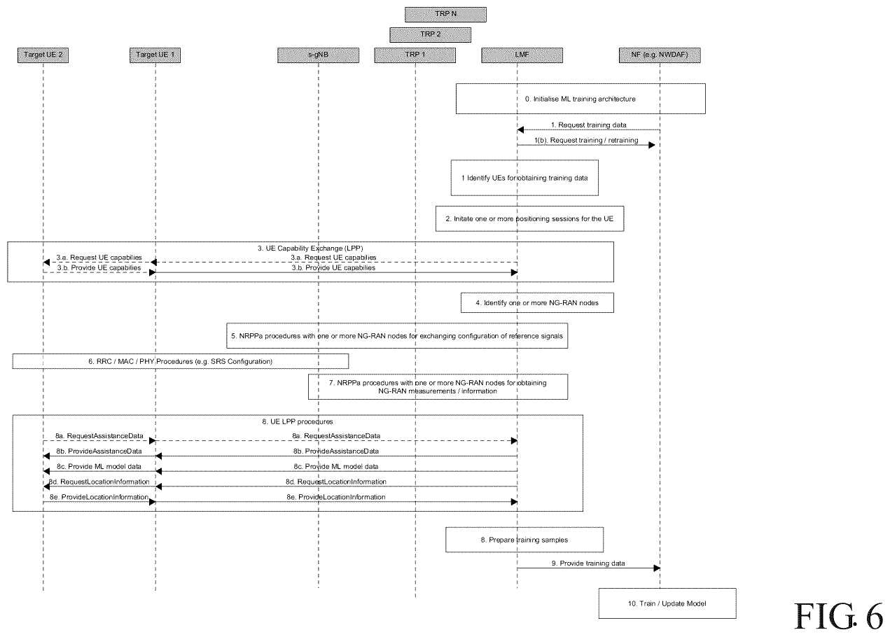

FIG. 6 illustrates an example stage 2 for obtaining features for training based on ML at the network side.

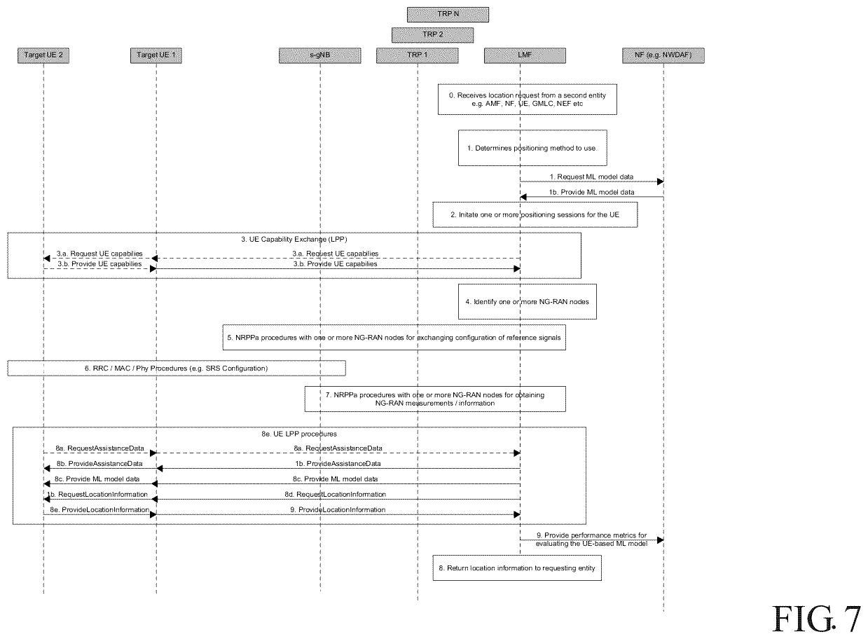

FIG. 7 illustrates an example stage 2 for UE-based positioning based on ML model and assistance data provided by the network.

In the following, obtaining features for training a model at the network side according to embodiments is described.

The machine learning model may be trained at the network side in at least one network nodes. The LMF shall configure at least one UE and/or at least one NG-RAN node to report the measurement of certain signals that they are configured to measure. Furthermore, the LMF may configure UE and/or NG-RAN node report at least one side information. Furthermore, the LMF may either request a UE to report its known or computed position and/or determine the position at the NW side using at least one measurement obtained by the NG-RAN nodes and/or the UE. The LMF may combine the information together so that the combined information form feature set for a single training example for training the machine learning model.

One way to identify a UE from a set of UE in a network is to identify UE based on their location. If a UE is known to be located within a machine learning assisted positioning area, then the LMF may configure such UE to provide training samples. Alternatively, some UEs may be deployed with a fixed location, for example, by the network operator. These UEs may serve the functionality of a position reference units (PRU). The knowledge of the PRU location may be used with the measurements made by PRU and/or measurement of the reference signals emitted by the PRU made at the NG-RAN network side to generate the training data for supervised learning. In other examples, the PRU location can be used to generate calibration data and/or to provide further assistance data. One concrete example, in case of channel charting used, there may be several UEs whose location is not known, such UEs appear similar in features to the PRU if they are close together. In such situation, the information about the reliable position knowledge of such PRUs can be used to recover physical dimensions to the channel chart.

For obtaining such training example, according to a variant, the LMF may configure at least two positioning sessions for the UE. In one of the positioning session, the UE is configured to report at least one measurements on at least one DL-RS it is configured to measure. In the second positioning session, the UE may report at least at least one measurements on at least one DL-RS it is configured to measure and/or at least report the position of the UE. The UE position may be obtained using at least one of the UE-based positioning methods. In line with this variant, in at least one of the ProvideLocationInformation message in the said positioning session, at least one of the following may be reported by the UE:
A source of a UE position, where source may indicate which of the RAT dependent or RAT-independent positioning method is used by the UE to determine the UE position, or it may indicate that the UE position is reported using static configuration, for example, during network provisioning the UE position of a stationary UE may be stored in the memory of the UE or obtainable from a database.
A quality and/or a reliability of UE estimates. This may be accuracy of UE measurements, or integrity parameters such as protection level, or integrity flagging (e.g. a flag 0/1 to indicate whether a protection level is larger than alert limit) or combinations thereof.

Alternatively, the LMF may configure the UE with at least two positioning sessions, in at least one positioning session, the UE may be configured to report at least one measurement made by the UE on at least one DL-RS the UE is configured to report. Using measurements reported by at least the NG-RAN node, the LMF may compute at least the UE position obtained by NG-RAN assisted approaches. Furthermore, the LMF may synchronize the measurements and side information reported by the UE, and/or the measurements and/or side information reported by the NG-RAN node and/or the UE position determined by the network to form features for training the network.

According to a second variant, the LMF may configure a UE to report the set of measurements and side information in a single message, so as to form a single training example for training the network.

The model may be trained either at the LMF side or the model may be trained at the NWDAF node.

If the model is trained at the NWDAF node, the LMF may configure the NWDAF node to train a model by specifying configuration parameters, the configuration parameters consisting at least one of the following:
1. Trained model type (for example: CNN, etc.)
2. Number of layers in the network
3. Number of nodes in each layer
4. Number of features to be used for training

Alternatively, the LMF may query the NWDAF, the LMF may query the NWDAF node for the features the LMF is expected to report.

In line with the variant where the LMF obtains the trained model from a second NW element, the LMF may be obtain the trained model by querying either NWDAF or NRF.

In the following, determining position of the UE at the network side according to embodiments is described.

If the trained model is deployed at the NWDAF side, then the LMF may send a request to the NWDAF node, where the request contains at least one measurement and/or at least one measurement from UE and/or at least one measurement from the NW and/or at least one side information. The NWDAF may use the features to determine the UE position and return the position to the LMF. The returned LCS information may include at least one of the following:
1. UE position
2. UE velocity
3. Accuracy information
4. Reliability information associated with the position estimate

Alternatively, the LMF may obtain the trained model and/or its configuration either by querying the NWDAF function or the NRF. The query may optionally include at least one capability from the UE capabilities supported by a UE. Once the model is obtained at the network, the LMF may use the features to estimate the position of the UE using the trained model.

In order to provide the features to the ML model to compute the position, the LMF may perform the following steps:

According to a first variant, the LMF may configure a UE with one or more positioning sessions, where the LMF may obtain measurements corresponding to a positioning method (such as DL-TDOA, DL-AOD, multi-RTT). If more than one positioning session is used, the LMF may synchronize the information from different positioning session to obtain a set of features needed for the trained model.

According to a second variant, the LMF may configure a UE with a specific message instructing the UE to report a certain set of features or a set of measurements needed for obtaining the features needed for the trained model.

The feature set above shall be provided to the trained model and the trained model shall give an estimate of the UE position.

In the following, determining a position of the UE at the UE-side is described.

For determining the UE-based position, the NW-entity (e.g. the LMF) may provide the UE with the trained model corresponding to the ML-assisted area where the UE finds itself in. The LMF may either determine that the UE is within such ML-assisted area utilizing either the UE position reported by the UE and/or measurements reported by the UE and/or the NG-RAN nodes and/or the information about the connection of the UE with the network (e.g. serving cells, TA, etc.). Alternatively, the UE may have determined that the UE has entered the ML-assisted area and request for NW-assistance.

The UE may (optionally) send UE capability using ProvideCapability message to the LMF, either unsolicited or in response to “RequestCapability” message.

The UE may send RequestAssistanceData message, where the RequestAssistanceData message either indicates the ML-assisted area or simply indicates that the UE has requested ML model for computing UE position.

The NW may provide the model using ProvideAssistanceData, where the model parameters are transferred. Alternatively, the model may be transferred via broadcast. Alternatively, the NW may indicate the source where the UE may obtain the model from. The source may be URL of the repository where the ML model may be stored.

The UE may obtain the side-information from the network, perform measurements to obtain the features needed by the model for computing position and determine the position.

The UE may optionally report the location determined using the ProvideLocationInformation message. The UE may either explicitly indicate to the LMF that the reported position has been obtained using ML approach or the NW may infer this information from the context of the positioning session where this message has been obtained. If the ProvideLocationInformation is transferred as a part of supplementary services, then indication may be provided that the positioning is obtained using ML approach.

A solution according to embodiments may, e.g., comprise one or more of the parts presented in the following.

It should be noted the solution parts are applicable to the different operation modes unless explicitly mentioned that the solution is only applicable for UE assisted, UE based, TRP-Assisted, LMF-assisted or LMF-based in the description.

At first, temporal anchors are described.

The 3GPP standard defines a PRU (position reference unit), which is a device with known position. A PRU may be used for calibration purpose of the positioning algorithms (determine the TRD (transmit receive delay), for example) for UL-TDOA, OTDOA or RTT based positioning algorithms using fixed anchors. Different PRU-types may exist and partly already defined by the 5G standard:
gNB like PRUs.
   PRU is used as anchor for DL-based positioning. In this case the PRU may transmit a DL-PRS synchronized to the network and can be considered as TRP of a simplified gNB.
   PRU is measurement unit for UL signals an may be equivalent to a LMU for UL-TDOA signal. In this case the LMU is also fully synchronized to the network.
   If the PRU is not sufficiently synchronized for UL- or DL-TDOA positioning methods, the PRU may be still useful for RTT measurements. Also in this case the PRU may be a simplified gNB.
UE type PRUs
   If used for down-link: The PRU provides measurements for DL-PRS signals.
   If used for uplink: The PRU transmits SRSs
UE type PRUs for SL based ranging:
The device is able to measure the distance to other UEs using sidelink signals.

It should be noted that a PRU may support different operation modes. A PRU may operate as PRU for SL based ranging and as PRU for network-based positioning. In the context of this invention, we consider mainly “temporal anchors” which may be a UE supporting UL- and/or DL-based positioning and communication with other UEs via sidelink. But a temporal anchor may be also implemented by a temporal available gNB-type PRU. A temporal anchor may report to the network and/or to other UEs its position and is capable to transmit and/or receive (and process) position reference signals to/from other UEs.

Another example for a temporal anchor may be a mobile terminal (e.g., a drone). After deployment of the network, e.g., a drone may be used as temporal anchor. In this case the model may be informed that for a limited time additional anchors are available and an update of the model training can be triggered.

Instead of ranging technologies defined by 3GPP the temporal anchors may support also other ranging or positioning technologies.

In the following, possible characteristics according to some embodiments are described.

In an embodiment, a UE is receiving a configuration message from a NW entity (like an LMF) or a second device (like UE or gNB), the configuration message including a condition information, wherein if the UE satisfy this condition the UE can behave as a temporal anchor or temporal PRU or PRU.

In an alternating embodiment, a UE the condition information is preconfigured or known to the UE, wherein if the UE satisfy this condition the UE can behave as a temporal anchor or temporal PRU or PRU.

In a related embodiment, the condition information includes one or more of the following:
an indication on the positioning absolute or relative accuracy
certainty
position quality
protection level
integrity flagging (1 bit signaling)

In a related embodiment, the UE may provide that its satisfies the condition based on PRU capability signaling.

In a related embodiment, as long as the UE becomes a temporal PRU, the UE reports its location information and measurements within the same positioning session.

In a related embodiment, the NW use the measurements and information from the temporal RPU to maintain the ML model or obtain score on the model validity.

In some examples the measurements can include ACS information derived ACS or a check on the ACS validity.

In a related embodiment, wherein the UE will refrain from reporting its position when the condition is no longer satisfied or/and indicate that condition is no longer held associated with the positioning session or with the one or more measurements or one more timestamps.

Temporal anchor is a device with known position AND capable to perform measurements on signals received from other devices and/or to transmit RS to other devices for relative ranging purposes.

Subject of capabilities any UE with known position may be a temporal anchor

The UE may inform the network about the capability to become a temporal anchor

The network may request from the UE to act as a temporal anchor for another device.

The network may provide to a UE information on available temporal anchors.

The temporal anchor may be a UE supporting sidelink ranging

The temporal anchor may be a device capable to transmit DL-PRS signals synchronized to the network and the related AD

The temporal anchor may be a device capable to measure ToA on SRS-pos signals relative to the network clock (synchronized to the network)

The temporal anchor may be a device capable to perform RTT measurements with neighboring

In a related embodiment, the temporal anchor performs sidelink based measurements with one or more target UEs. The measurements can be related to a sidelink range or/and direction information, between the temporal anchor and the UE to be located.

The sidelink ranging may be subject of Rel. 18 of the 3GPP standard. Instead of sidelink based ranging other ranging technologies like UWB, Lidar, radar, other RF signal-based ranging methods (WLAN based technologies, for example) may be applicable.

In the following, temporal sensors are described.

Each device with known position and the capability to perform AND report measurements on received signal can act as sensor for the training of a neural network or generation of “fingerprints”. The position (“labels”) together with the measurements performed by the sensor or by the network on signals emitted by the sensor form a set of training data.

We distinguish different types of sensors:

“Dedicated sensors” may be used for the initial setup of a network. For example robots determine its position by RAT independent solutions and provided for many positions measurement data to train a model.

“Monitoring sensors”: Devices at a fixed position—either known or unknown—may detect changes in the environment and may trigger the need to update a model.

“UE type sensor”: If the training is limited to areas where RAT dependent technologies are sufficient, UEs may act as sensor by termining the position using the RAT dependent technologies like RTT or TDOA based methods and providing measurements to the training entity to setup models for positioning methods complementary or independent to TDOA or RTT based technologies.

“Temporal sensors”: Similar as for the UE type sensor the measurements together with the position is provided to the training network. A sensor becomes a “temporal sensor” if the position can be calculated with the support of temporal available information only, e.g.: signals received from or measured by temporal anchors.

In the following, an identification of “NLOS areas”−“area state identification” according to some embodiments is described.

The method (selected algorithm or selection of the model) may depend on the area. A localization area may be split in different sub-areas:

“LOS areas”: In LOS areas the number of LOS links is sufficient, and the positioning may be mainly based on the LOS links.

“Partial NLOS area”: LOS links are available, but the number is not sufficient for reliable positioning.

“Critical NLOS area”: Most signals are received under NLOS condition.

Considering changes of the environment or moving obstacles that cause temporal blockage of a link, the state of an area may change (temporal or permanent). A LOS area may become a “partial NLOS area” if some links are blocked or a “partial NLOS area” may become a “critical NLOS area” if more LOS links are blocked.

Assuming parts of the CIR will not change when the area state changes a maintenance of the trained model is feasible if sometimes the area enters the “LOS state” and during the LOS state the position can be calculated and training data can be provided to the model.

In another example the area state identification determines the number of required temporal anchors sufficient to calculate a reliable position. If the number of available temporal anchors is sufficient and the position can be calculated with sufficient accuracy a model update can be triggered.

Possible characteristics may, e.g., comprise:
The UE reports to the network for each received reference signal the signal characteristics comprising at least one of the following information
   Signal strength
   LOS/NLOS probability
   Information on received beams
   CIR parameters like estimated K-Factor
   etc.
The UE use UE-based OTDOA as preferred positioning method. The UE may indicate to the network that the number of TRPs are not sufficient

In the following, ML assisted areas are described.

The information about the existence of ML assisted areas may be indicated to the UE by the network. This may be done via broadcasting posSibs or other means. Alternatively, when the UE enters a ML assisted area, the UE can receive unicast, groupcast or broadcast signaling to be informed of the existence of such areas.

For each area the AD may include the ML assistance status, which is one of the following states:
No AI/ML support for the area.
The model for this area is still in the training phase. The model is requesting further data for model training.
The model is partially trained. To further determine the availability of ML/AI support a position estimate may be required and/or measurement signal classification. For example, the model was trained using LOS data, but for temporal blockage of one or more links the trained model captured sufficient information. For NLOS area the model may be not yet trained. The model looks for further input data to cover also NLOS areas.
The model covers also NLOS areas and is able to determine the position in NLOS areas also

For each area the model status may change if the environment changes. Further refinements of the model state definition may be considered defining the level of inconsistency of the recently received measurements from the area, for example. This can be defined by a model accuracy level, for example.

A UE may also deduce that it has entered an ML-assisted areas by means of measurement performed on certain DL signals (e.g. PSS, SSS, CSI-RS, DL-PRS, etc.) and/or on sidelink reference signals and/or uplink reference signals (e.g. UL-PRS).

A network entity (e.g. the LMF or NG-RAN node) may provide configuration to the UE indicating the UE to perform measurement on certain reference signals. The UE may be configured either to report such measurements and/or analyze the measurement to determine whether the UE has entered a ML-assisted area. The UE may be further provided by thresholds to compare the measurement to, in order to determine whether the UE has entered such ML-assisted area. If the UE determines that it has entered the ML-assisted area, then it may signal the NW

A network entity (e.g. LMF or NG-RAN node) may determine that a UE has entered a ML-assisted zone. The LMF may determine this information making use of at least one information:
1. Measurements reported by NG-RAN node, which may include one or more of the following-RSRP on uplink reference signals, TA used by the UE, AoA, RToA, RxTxTimeDiff (time difference between reception of UL signal and the time of transmit of downlink reference signal)
2. Logical information, as the information about serving cell (primary and/or secondary)
3. Measurements reported by the UE, which may include one or more of the following—RSRP on downlink reference signals, RSTD, AoD, TA, RxTxTimeDiff (time difference between reception of UL signal and the time of transmit of downlink reference signal)

The LMF may indicate the UE that it has entered a ML-assisted area. Furthermore, the LMF may indicate the availability of additional assistance data available to the UE. Furthermore, the LMF may additionally (and/or optionally) signal the UE to report additional measurements and/or additional information to report.

The additional assistance data applicable to the ML area may comprise any one of the following:
i. ML model parameters including at least one of the following:
   a. ML model
   b. Features of ML model
   c. Coefficients describing the ML model and/or a part thereof.
   d. Additional assistance data in making measurement, for example
ii. The additional information to report may be
   a. Information associating the measurement from one positioning session to another positioning session
   b. Coherence between measurements

In the following, an ACS definition and usage according to embodiments is provided.

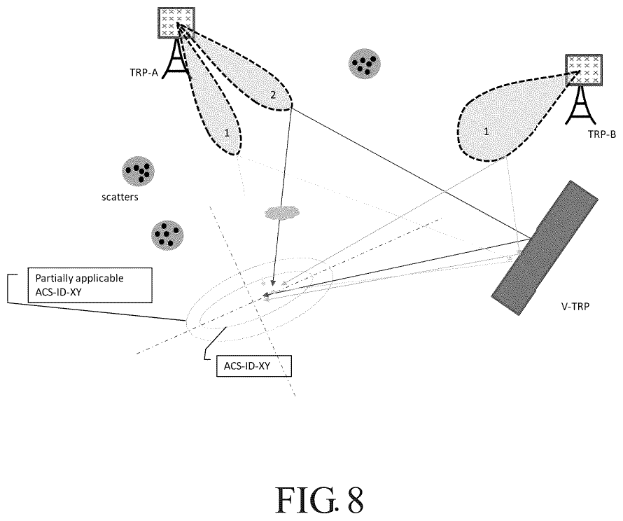

Regarding an ACS definition, according to one aspect, the positioning system includes one or more Association and Calibration Spots (ACSs), the ACS refers to a geographical region which is associated with information related to the channel characteristics governed in this spot. FIG. 8 shows an example of the ACS realization, ACS has an identifier ID and is associated with the 2 Resources from TRP-A and one resource from TRP-B. In some examples, the ID is implicit derived from the ACS characteristics such as absolute, relative position, distance or direction information. It should be noted that association is not limited with the beam direction but can also be related with the transmit characteristics or/and receiver assumptions.

Regarding a validity region of ACS, in a related aspect, the FIG. 8 also shows that the ACS information are valid in a given region and partially valid or not valid outside this region. This can be for example related to validity of the ACS Information at different heights or an indication of the change in the area and expected relevance for the desired channel information such as the V-TRP. In a positioning area the number of required ACS for a usage relates to a tradeoff between signaling complexity, availability of information and the required granularity. The NW can identify the validity information for each ACS as well as number of ACS information needed based on environment related information and/or the ML model performance.

Regarding a calibration usage, several aspects are supported by the ACS usage within the solution: In one option, the usage, is related to a provided calibration label, enables the measurement device to identify the measurement characteristics or receiver assumptions needed estimate one or more measurements at the measurement device. In one example, the UE in (UE-assisted and UE-based modes) or TRP performing DL or/and UL measurements uses an ACS information to set a detection method or threshold to derive the ToA, RSRPP or AoA. The ACS information in this example can be related to the expected reception level of the LOS path in relation to later and likely stronger multipath paths. Here, it should be particularly noted that the usage, is related to a provided calibration label, enables the measurement device to identify the measurement characteristics-of one or more measurements at the measurement device. This may, e.g., be related to the monitoring usage described above.

Regarding an association usage, in a second option, the ACS provides association information to assist a UE or TRP to report the additional paths and direction information. In one example, a UE or TRP may be capable of reporting a configurable number of paths and the number of identified paths or directions is beyond the configured number of paths. The ACS can hence in this example provide guidance for the UE or TRP, to associate the measurement paths and/or direction with the ACS information and identify the desired information for the measurement report.

In a related implementation, the ACS information is associated with the one more resource from one or more antennas corresponding to one or more transmitters or receivers. The ACS information can hence provide information from the multiple antennas of the same TRP or UE and/or between different TRPs or UEs.

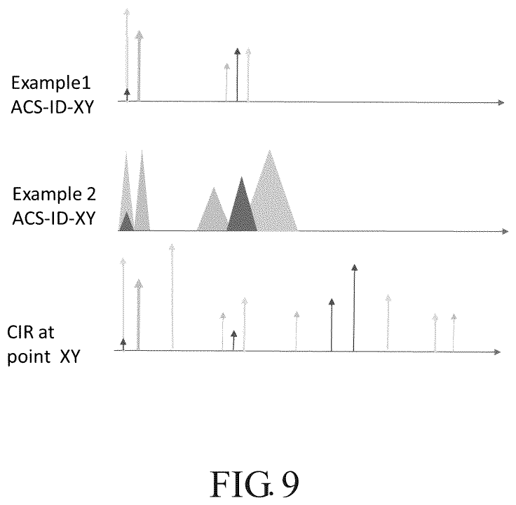

FIG. 8 and FIG. 9 show two implementations of ACS information providing in the first implementation multiple path information and optionally the magnitude information of each path according to embodiments. In the second implementation the paths are provided within a time window for the expected certainty of these path and optionally the magnitude information. Clearly when compared with the CIR measured the ACS only includes a subset of the information.

In particular, FIG. 8 illustrates an association and calibration spot according to an embodiment.

FIG. 9 illustrates examples for ACS information according to embodiments for the scenario of FIG. 8.

Regarding ACS for UE based, in one aspect the solution presents methods to provide the ACS information for a UE in UE-based mode. Wherein the UE is configured to receive from the NW one or more PRS configuration for more or more antennas of one or more transmitting devices and; receiving from the NW entity a set of parameters comprising information on at least one ACS and; wherein the UE is to use this information to determine its position.

The information can be a spot location defined by a ground truth label and an ACS validity region

Regarding ACS identification in UE based and UE-assisted, in a related aspect, the solution provides a method to identify the relevant ACS information in the positioning area. For UE-based, the NW needs to identify a subset of ACSs relevant for the UE from the set of ACS supported in the positioning area. For this several options are applicable as standalone or in combination with each other. In one option, the NW can make use of the reported UE position and uncertainty or derive a UE position based on reported measurements and identify the ACS area. In a second option, the sidelink information can be used to a second UE in to identify the area; these sidelink information can be reported from the second UE (for example being a temporal PRU) or by the device itself or inferred by the NW from the reported measurements. In a third option, the NW can make use of UL reference signal reported from one or more TRPs and use these measurements by the ML model to extract similarities and identify the relevant ACS subsets. In a fourth option, the UE may provide information on the movement type or velocity information to identify the number of ACSs predicted over one or more potential tracks. Alternatively, to the last option the UE may request from the NW multiple ACS information to be used to compute its position or report a measurement.

Regarding ACS multistage information, in a further related aspect, the provided ACS information can be provided in a multi-stage approach. That is in a first stage coarse ACS information are provided wherein the refinement or granularity of ACS information occurs in later stages based on the measurements, matching outputs with the previous stages or changing conditions.

Regarding ACS information, the ACS includes one or more of the following associated with one or more resource or resource sets:
One or more delay paths for the LOS and/or multipath components
One or more directional paths LOS and/or multipath components
Power/Magnitude information for one or more directional and delay path associated with one resource or one path per resource
Expected LOS delay and magnitude to a multipath component such as the maximum peak expected by a given resource
Window configuration indicating the expected delay or direction of the LOS or multipath to be applied on the measurements or to be reported
Window configuration indicating the expected delay or direction of the LOS or multipath not to be applied on the measurements or to be reported
A validity region with information on the validity where the information can be soft or hard values
Correlation of ACS Information in a given area and number of updates ACSs needed or expected
An indication form the measurement unit on the applicability of the received ACS information on the received measurement and/or configured measurement report

In the following, an outline of the procedure related to model maintenance is described.

The life cycle management of a model covers at least the following phases/states:
Initial training during deployment phase:
The scope of the initial training is the setup of the model to be able to estimate the position or to assist other positioning technologies at least for parts of the network with full or reduced accuracy.
   For network-based positioning the trained model is part of the network
   For UE-based positioning the trained model is deployed to the UEs in the network. This can be either done by the network operator or by the device vendor. For different areas, different models may be required
   For UE-assisted positioning parts of the model (e.g.: area type identification) may be deployed to the UE
Fine-tuning of the model:
Using information from UEs deployed in the network (e.g.: IoT devices) additional training data can be provided to the model and the model updated accordingly
   Provide additional training data for “LOS regions” to prepare the network for changes in the environment (e.g.: LOS region becomes a NLOS region)
   Provide additional training data for NLOS regions using temporal anchors or information from UEs in the same ACS.
Incremental update of the model in case of changes of the environment:
   Continuous update of the model similar as the fine-tuning phase
   Identify for each ACS the model status (“valid”, “update in progress/limited accuracy”, “invalid”)
Detect invalid model and enter “full” retraining (=new initial training): If the incremental update fails a full retraining may be required.

The possible procedure may, e.g., comprise one or more or all of the following elements:
ACS information:
   The network may capture and manage for each ACS the related AD.
   The UE may request from the network the ACS information related to its current position.
In another embodiment the ACS data may include (or defined) the information used as input data for the training.
The UE may first determine a coarse position to identify the related ACS information
   The ACS information may be used for
      Identification of the “area state” (LOS/NLOS region).
      Check the consistency of the measured data with the characteristics provided by the ACS information.
      Search for UEs in the same ACS.
   The UE may request from the network available temporal anchors related to the ACS
   The UE may request from the network to activate temporal anchors.
The UE may perform measurements and may report the data related to ACS to the network. The network may use these measurements to update the ACS information or as input data for a model training update.
Depending on the type (LOS or NLOS) of ACS region the UE or the network may select the appropriate position method, or the ACS information are additional input for a (common) positioning method.
The ACS information may also control the parts of the CIR to be reported to the LMF.
   The CIR may include different types of multipath cluster. The reporting method (delay and magnitude only, or delay and complex valued CIR, or delay, magnitude and phase) may depend on the type of the cluster
      At least for LOS path/cluster a full reporting (complex valued or phase) is assumed.
      For Virtual TRP the phase may provide additional information
      For other clusters a simplified (delay and magnitude only) reporting may be sufficient.

Based on this the following procedure according to embodiments is provided:

### 1) Initial Training:

initial training using simulation data (training for LOS areas)
identify areas requiring “NLOS model initialization
   Statistics over deployed IoT devices
   “robot” scanning areas requiring model initialization
   uncertainty estimation by the initial model (model trained on simulations w.r.t. real-world characteristics) shows low confidences in environments with different/changed characteristics, e.g., model trained on LOS, returns low confidence values in environments with NLOS
   optional: “triggered initialization for NLOS areas” by
      starting a drone
      Optional: robot scans other areas
      uncertainty measure of the (positioning) model; confidence varies with known to unknown data, I.e., training data and inference data deviate

### 2a) “Operation Phase”, Network-Based Positioning

identify area state
Case 1: Change from NLOS-to-LOS
   update fingerprint using LOS positioning
Case 2: Change from LOS-to-NLOS
   search for temporal anchors
   update model if temporal anchor is available (and has sufficient quality)
   If no temporal anchor is available: check model status (last update still valid?)
      different model states for each ACS
   report estimated position together with model status
Case 3: No change of the reception state
   identify related ACS
   check model status of model for ACS
   If update is recommended search for temporal anchors
   update model if temporal anchors are available

### 2b) Operation Phase, UE Based Positioning

a) New UE: Copy model to UE
b) UE has already received a model
   i) Identify ACS area
   ii) Check model status for related ACS (request model status from network)
   iii) Request model update if necessary
   iv) If no model update is available
      Check positioning accuracy estimate
      Inform network on required update if necessary.

In the following, the training phase according to some embodiments is described, which may, e.g., be applicable, e.g., for LMF, UE and TRP procedures, e.g., similarly or analogously. It should be noted that e.g., one or more or all of the following may, e.g., be implemented:
Blackbox global model
   Pretrained on known configurations with appropriate channel characteristics
   Pretraining may be based on simulations or real-world data or mixtures thereof
   Description of parameters may be unknown to the “user”
   A global model may be deployed to participants to do positioning
   A global model may be deployed and calibrated with a local model
      Such a local model incorporates the output of the global model and calibrates its parameters to a local environment or configuration
      Such a local model may also replace parts of the global model for calibration
   Parts or a compressed version of the global model may be deployed for local calibration
   A global model may also only listen to information and learn the configuration and characteristics implicitly
      Such a model may reconstruct or may embed the global or local environment
      Such local models my generate data to update a global model
   Participants may record and learn a local model without references as they measure the similarity between measurements
      Such similarities may depend on side-information such as time, velocity, distance, orientations, absolute positions, other senor information, e.g., Camera/Visual Inertial Odometry, GNSS, IMU, etc.
      A local model may interpret its manifold to identify e.g., walls or other potential temporal anchors
Transparent
   A potential architecture of a global or local model may be deployed to the participants
      Such an architecture may also provide the structure and pre-trained parameters
      Such an architecture may provide requirements for a local or global model
      Such an architecture or parts may be exchanged or retrained
Combination
   Parts of a global graph may be backboxes and others may be transparent
Supervised training
   Pretraining, may be performed either on simulations, real-world data or mixtures thereof; measurements and corresponding references, I.e., positions are available;
   Calibration, may be performed either on simulations, real-world data or mixtures thereof; Errors of estimates and reference participants may be available as calibration values;
Unsupervised training
   Pretraining, may be performed on simulations, real-world data or mixtures thereof; references may not be available; similarity estimates, e.g., Jensen Shannon-, Wasserstein- or Kullback Leibler-divergence between measurements may be available;
   Calibration, may be performed on simulations or real-world data or mixtures thereof; again, references may not be available;
   Scaling and rotation of a manifold may be performed with few similarity measures in combination with side-information, e.g., distance, orientation, position, that are part of the local or global graph
Semi-supervised training
   Pretraining, may be performed similar as unsupervised training and few reference may be available to (semi) supervised calibrate a model
   E.g., a Blackbox model pretrained on simulations may be calibrated on few representative real-world data with reference information
      Reference information may be e.g., virtual, temporal anchors with high confidence
. . .

In the following, model deployment/monitoring according to embodiments is described:
Model validity and correlation with a reference model
Model performance score
Monitoring reference points or PRU information

### Black-Box Deployment

Cascaded deployment
Use consecutive model to finetune/adapt to target (site/device)

### Transparent Deployment.

Only fractions (layers/weights) of the network are deployed to fine-tune/calibrate site- or device-specific

### Compression

The models may be compressed (e.g., from 32 to 8 bit) to reduce network traffic and cost; the accuracy of the models remains unchanged.
The models may be compressed in the global pool or locally.

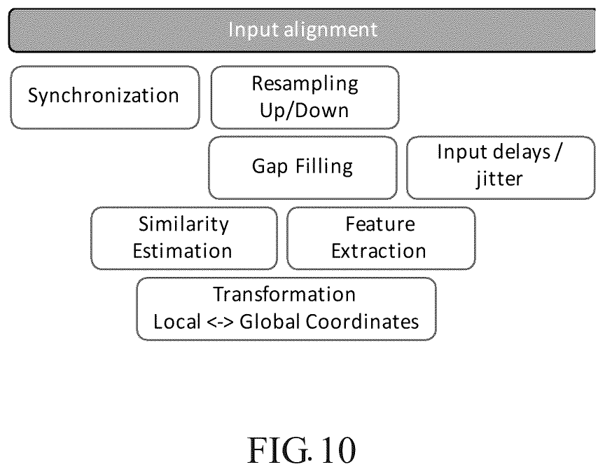

FIG. 10 illustrates details on potential pre-processing steps according to embodiments. It should be noted that also a nonlinear N/LOS classification, quantification or uncertainty estimation may be part of a potential preprocessing scheme.

FIG. 11 illustrates a scheme of a particular model identification procedure according to an embodiment. Based on “procedures” a specific local model may be selected from a global pool of models w.r.t. a description or configuration. The full or parts of a pre-deployed “local” model may again be re-deployed to other UEs or updated in the inference phase or updated to the global pool.

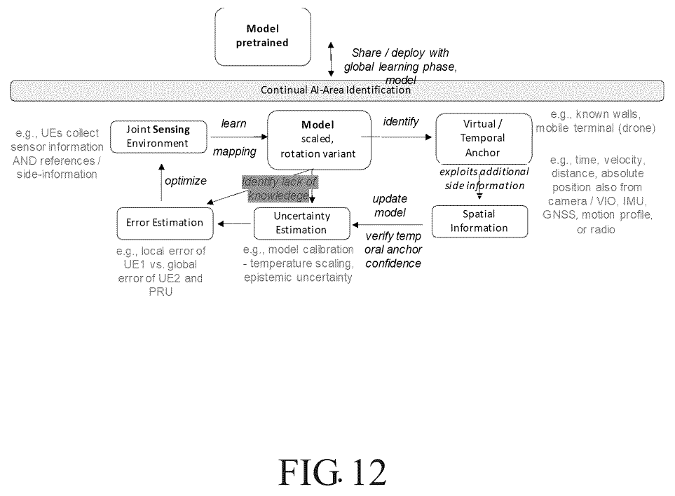

FIG. 12 illustrates an exemplary scheme of a continual “model identification” procedure according to an embodiment. The model identifies a lack of knowledge, may be represented by a knowledge/data gap in the training phase, that results in high uncertainty in the inference/live phase. A potential input may, e.g., be a (set of) channel impulse response/s or descriptive parameters thereof, e.g., TOA, AOA, AOD, TOT, TDOA, . . . , side-information (see text in FIG. 12). A potential output may, e.g., be a position, derivates thereof, probabilities/variance (uncertainty), side-information. This relates to monitoring of a trained model output.

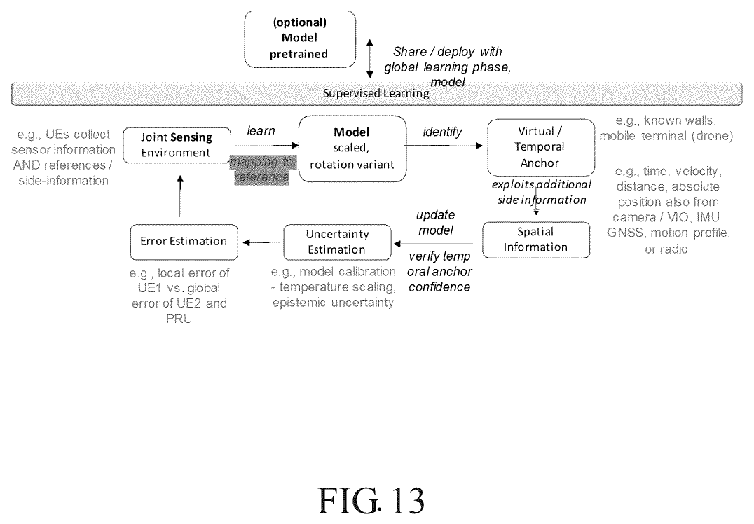

FIG. 13 illustrates an exemplary scheme of our proposed supervised learning procedure according to an embodiment. Reference knowledge, may be absolute or relative “spatial” information that may contribute as exogenous information to a positioning task. Absolute knowledge may be a position; relative information may be side-information.

Potential input: (set of) channel impulse response/s or descriptive parameters thereof, e.g., TOA, AOA, AOD, TOT, TDOA, . . . , side-information (see FIG. 13). A potential output may, e.g., be: position, derivates thereof, probabilities/variance (uncertainty), side-information.

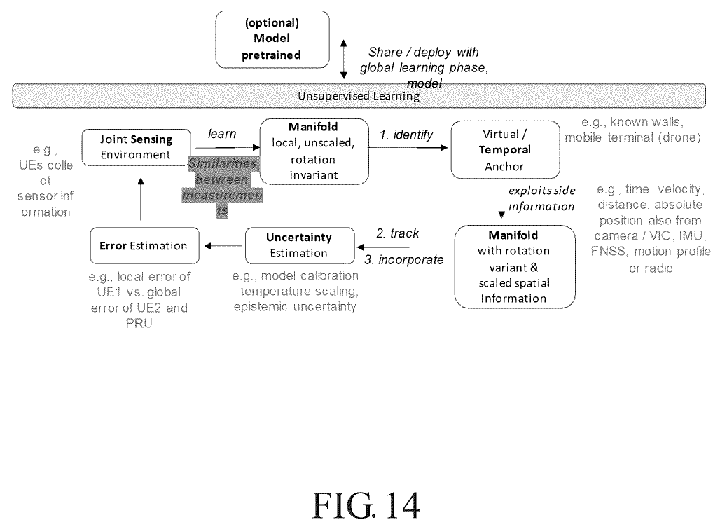

FIG. 14 illustrates a scheme of an unsupervised learning procedure according to an embodiment. Procedure exploits similarities, that are defined by side-information such as distance, velocity, time, or absolute spatial information such as temporal anchors, ACSs, etc. A virtual scale/rotation-invariants will be transformed to a real-world scale and rotation-variants with side-information. From there, a downstream positioning or classification task may be performed. A potential input may, e.g., be a (tuple or triplet of sets of) channel impulse response/s or descriptive parameters thereof, e.g., TOA, AOA, AOD, TOT, TDOA, . . . , side-information (see FIG. 14; to allow real-world scale and translation of the manifold); intra similarities of these tuples, triplets: A potential output may, e.g., be: a similarity metric; implicit position, clustering, interpretable disentanglement of the manifold, classification.

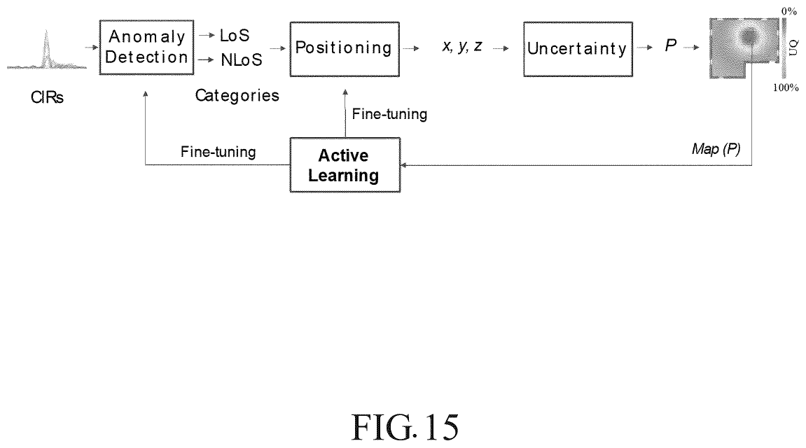

FIG. 15 illustrates a global perspective on a continual learning procedure according to an embodiment. It should be noted that a temporal anchor or ACDs may be incorporated in each step. A potential input may, e.g., be a (set of) channel impulse response/s or descriptive parameters thereof, e.g., TOA, AOA, AOD, TOT, TDOA, . . . , side-information (see FIG. 15). A potential output may, e.g., be a position, derivates e.g., velocity, distance, acceleration, orientation, thereof, probabilities/variance (uncertainty), side-information.

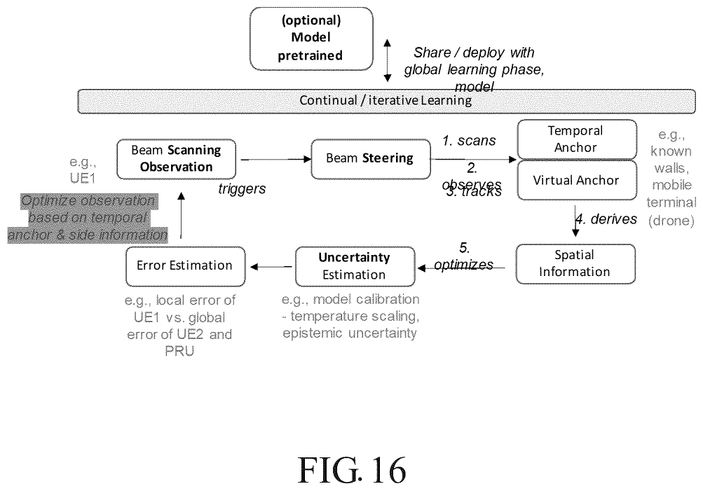

FIG. 16 illustrates a processing scheme of a continual and iterative learning pipeline according to an embodiment. An observation unit scans and steers a beam management unit to identify, observe, and track the evolution of temporal anchors and ACSs to exploit spatial information that these units provide to iteratively update the observation unit. An uncertainty and error estimation component provides additional confidence measures to analyze the information gain per iteration and to improve the observation process.

A potential input may, e.g., be a (set of) channel impulse response/s or descriptive parameters thereof, e.g., TOA, AOA, AOD, TOT, TDOA, . . . , side-information (see FIG. 16), states, rewards, possible actions. A potential output may, e.g., be a position, derivates e.g., velocity, distance, acceleration, orientation, thereof, probabilities/variance (uncertainty), side-information.

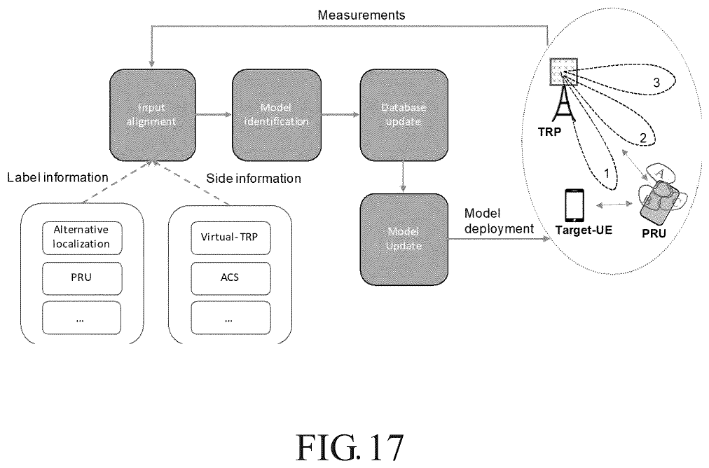

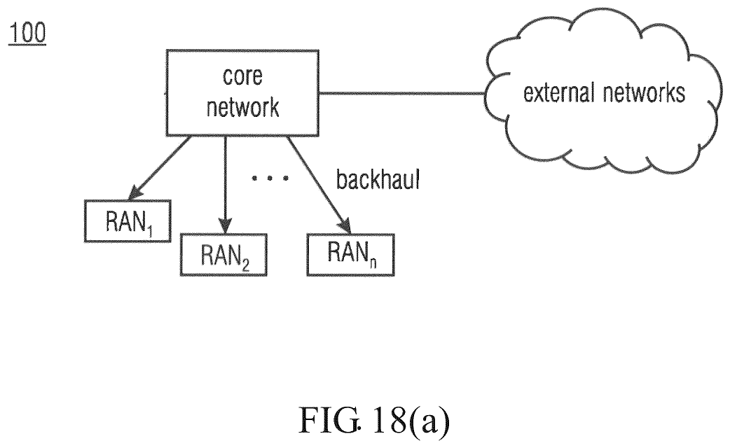

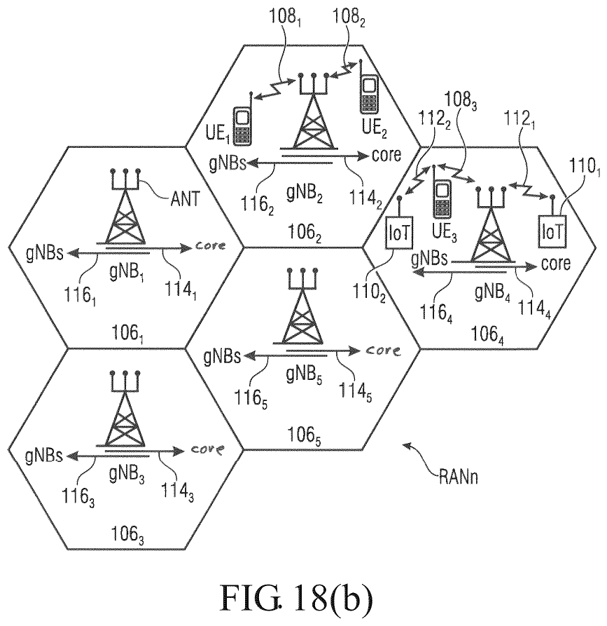

FIG. 17 illustrates an abstract scheme of a model identification procedure according to an embodiment.

Although some aspects of the described concept have been described in the context of an apparatus, it is clear that these aspects also represent a description of the corresponding method, where a block or a device corresponds to a method step or a feature of a method step. Analogously, aspects described in the context of a method step also represent a description of a corresponding block or item or feature of a corresponding apparatus.

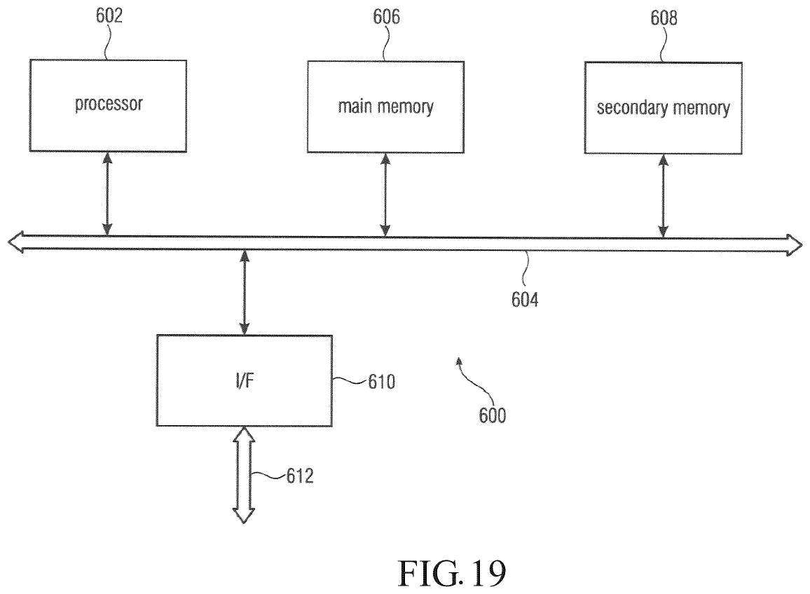

Various elements and features of the present invention may be implemented in hardware using analog and/or digital circuits, in software, through the execution of instructions by one or more general purpose or special-purpose processors, or as a combination of hardware and software. For example, embodiments of the present invention may be implemented in the environment of a computer system or another processing system. FIG. 19 illustrates an example of a computer system 600. The units or modules as well as the steps of the methods performed by these units may execute on one or more computer systems 600. The computer system 600 includes one or more processors 602, like a special purpose or a general-purpose digital signal processor. The processor 602 is connected to a communication infrastructure 604, like a bus or a network. The computer system 600 includes a main memory 606, e.g., a random-access memory, RAM, and a secondary memory 608, e.g., a hard disk drive and/or a removable storage drive. The secondary memory 608 may allow computer programs or other instructions to be loaded into the computer system 600. The computer system 600 may further include a communications interface 610 to allow software and data to be transferred between computer system 600 and external devices. The communication may be in the from electronic, electromagnetic, optical, or other signals capable of being handled by a communications interface. The communication may use a wire or a cable, fiber optics, a phone line, a cellular phone link, an RF link and other communications channels 612.

The terms “computer program medium” and “computer readable medium” are used to generally refer to tangible storage media such as removable storage units or a hard disk installed in a hard disk drive. These computer program products are means for providing software to the computer system 600. The computer programs, also referred to as computer control logic, are stored in main memory 606 and/or secondary memory 608. Computer programs may also be received via the communications interface 610. The computer program, when executed, enables the computer system 600 to implement the present invention. In particular, the computer program, when executed, enables processor 602 to implement the processes of the present invention, such as any of the methods described herein. Accordingly, such a computer program may represent a controller of the computer system 600. Where the disclosure is implemented using software, the software may be stored in a computer program product and loaded into computer system 600 using a removable storage drive, an interface, like communications interface 610.

The implementation in hardware or in software may be performed using a digital storage medium, for example cloud storage, a floppy disk, a DVD, a Blue-Ray, a CD, a ROM, a PROM, an EPROM, an EEPROM or a FLASH memory, having electronically readable control signals stored thereon, which cooperate or are capable of cooperating with a programmable computer system such that the respective method is performed. Therefore, the digital storage medium may be computer readable.

Some embodiments according to the invention comprise a data carrier having electronically readable control signals, which are capable of cooperating with a programmable computer system, such that one of the methods described herein is performed.

Generally, embodiments of the present invention may be implemented as a computer program product with a program code, the program code being operative for performing one of the methods when the computer program product runs on a computer. The program code may for example be stored on a machine readable carrier.

Other embodiments comprise the computer program for performing one of the methods described herein, stored on a machine readable carrier. In other words, an embodiment of the inventive method is, therefore, a computer program having a program code for performing one of the methods described herein, when the computer program runs on a computer.

A further embodiment of the inventive methods is, therefore, a data carrier or a digital storage medium, or a computer-readable medium comprising, recorded thereon, the computer program for performing one of the methods described herein. A further embodiment of the inventive method is, therefore, a data stream or a sequence of signals representing the computer program for performing one of the methods described herein. The data stream or the sequence of signals may for example be configured to be transferred via a data communication connection, for example via the Internet. A further embodiment comprises a processing means, for example a computer, or a programmable logic device, configured to or adapted to perform one of the methods described herein. A further embodiment comprises a computer having installed thereon the computer program for performing one of the methods described herein.

In some embodiments, a programmable logic device, for example a field programmable gate array, may be used to perform some or all of the functionalities of the methods described herein. In some embodiments, a field programmable gate array may cooperate with a microprocessor in order to perform one of the methods described herein. Generally, the methods may be performed by any hardware apparatus.

While this invention has been described in terms of several embodiments, there are alterations, permutations, and equivalents which fall within the scope of this invention. It should also be noted that there are many alternative ways of implementing the methods and compositions of the present invention. It is therefore intended that the following appended claims be interpreted as including all such alterations, permutations and equivalents as fall within the true spirit and scope of the present invention.

ABBREVIATIONS

| Abbreviation | Definition |
|---|---|
| 3GPP | third generation partnership project |
| 5GC | 5G core network |
| BS | base station |
| CSI-RS | channel state information reference signal |
| DMRS | demodulation reference signal |
| DOA | direction of arrival |
| E-CID | enhanced cell ID |
| eNB | evolved node b |
| E-SMLC | evolved serving mobile location center. |
| E-UTRA | evolved UMTS terrestrial radio access |
| gNB | next generation node-b |
| GPS | Global Positioning System |
| LMF | location management function |
| LMU | location measurement unit |
| LPP | LTE positioning protocol |
| LTE | Long-term evolution |
| NG | next generation |
| ng-eNB | next generation eNB |
| NG-RAN | either a gNB or an ng-eNB |
| NR | new radio |
| NRPPa | new radio positioning protocol a |
| OTDOA | observe time difference of arrival |
| PRS | positioning reference signal |
| PTRS | phase tracking reference signal |
| QCL | quasi colocation |
| RAN | radio access network |
| RP | reception point |
| RSTD | reference signal time difference |
| RTOA | relative time of arrival |
| RTT | round trip time |
| SA | Standalone |
| SRS | sounding reference signal |
| TDM | Time Domain Multiplexing |
| TOF | time of flight |
| TRP | transmission reception point |
| RS | reference signal |
| QCL | quasi co-located |
| AoA | Angle of Arrival |
| AoD | Angle of Departure |
| PAS | Power Angular Spectrum |
| NR | New Radio |
| gNB | next generation node-b |
| GPS | Global Positioning System |
| LMF | location management function |
| LMU | location measurement unit |
| LPP | LTE positioning protocol |
| LTE | Long-term evolution |
| NG | next generation |
| ng-eNB | next generation eNB |
| NG-RAN | either a gNB or an ng-eNB |
| NR | new radio |
| CA | carrier aggregation |
| CAM | Cooperative Awareness Message |
| DAS | distributed antenna systems |
| DL | Downlink |
| FL | Frequency layer |
| FC | Frequency component. This is either a |
| | BWP of a wideband carrier or |
| GNSS | Global navigation satellite system |
| OOC | Out-Of-Coverage |
| PSFCH | Physical Sidelink Feedback Channel |
| P-UE | Pedestrian UE: should not be limited to |
| | pedestrians, but represents any UE |
| RS | Reference signal |
| RE | resource elements |
| SINR | Signal to interference and noise ratio |
| SL | Sidelink |
| SPRS, SP- | Sidelink positioning reference signals |
| V2X | Vehicle to anything |
| VRU | Vulnerable road user |
| V-UE | Vehicular UE |
| BWP | Bandwidth Part |
| TEG | Timing Error Group |
| ZC | Zadoff-Chu sequence |
| UE | User equipment |
| UL | Uplink |
| Uu (interface) | Interface between UE |
| ToA | Time of Arrival |
| TDOA | Time Difference of Arrival |
| LOS | Line of sight |
| PRU | Positioning reference unit |
| ToF | Time of flight |

1. A user equipment of a wireless communication system,
wherein the user equipment is configured to determine and/or to receive information on an applicability of a machine-learning model, and/or
wherein the user equipment is configured to determine and/or to receive information that the user equipment is located in a machine-learning assisted area.

2. A user equipment according to claim 1,
wherein the user equipment is a sensor unit and/or wherein the user equipment has sensor unit capabilities.

3. A user equipment according to claim 1,
wherein the user equipment is configured to receive the information that the user equipment is located in a machine-learning assisted area from a network entity of the wireless communication system.

4. A user equipment according to claim 1,
wherein the user equipment is configured to receive information from a network node of the wireless communication system comprising information on at least one of the following
that no AI/ML support for the area in which the user equipment is located is provided,
that the model for the area in which the user is located is still in the training phase, and that the model is requesting further data for model training,
that the model is partially trained, and that to further determine the availability of ML/AI support, a position estimate or a distance estimate or a range estimate may be required and/or measurement signal classification,
that the model covers also NLOS areas and is able to determine a position or a distance in NLOS areas also,
that the model is available, but the accuracy may be degraded, for example due to changes in the environment,
a mode of operation, for example a need for update operation mode due to a confidence decrease and/or for example an update phase operation mode and/or for example a high-confidence operation mode in an NLOS area.

5. A user equipment according to claim 1,
wherein the user equipment is configured to conduct one or more measurements by measuring one or more reference signals, and
wherein the user equipment is configured to determine whether or not the user equipment is located in a machine-learning assisted area by receiving an indication from the network entity of the wireless communication system, and/or by receiving assistance data required for the identification of a machine-learning assisted area from the network entity of the wireless communication system; and/or
wherein the user equipment is configured to identify the machine-learning assisted area by analyzing the one or more measurements; and/or
wherein the user equipment is configured to transmit information on the one or more measurements to an entity of the wireless communication system and to obtain information on whether or not the user equipment is located in a machine-learning assisted area from said entity or from another entity of the wireless communication system in response to transmitting said information on the one or more measurements.

6. A user equipment according to claim 5,
wherein the user equipment is configured to measure the one or more reference signals being one or more downlink reference signals, and/or by one or more sidelink reference signals and/or one or more uplink reference signals.

7. A user equipment according to claim 6,
wherein said one or more downlink reference signals are one or more of a PSS, a SSS, a CSI-RS and a DL-PRS, and/or wherein the one or more uplink reference signals are one or more UL-PRS and/or one or more SRS.

8. A user equipment according to claim 1,
wherein the user equipment is configured to receive one or more thresholds, and
wherein the user equipment is configured to compare the one or more measurements with the one or more thresholds to determine whether or not the user equipment is located in a machine-learning assisted area.

9. A user equipment according to claim 8,
wherein the one or more thresholds comprise at least one of an RSRP threshold and an SNR threshold,
wherein, depending on the RSRP threshold and/or the SNR threshold, the user equipment is configured to trigger an activation or deactivation of the machine-learning model.

10. A user equipment according to claim 1,
wherein the user equipment is configured to conduct one or more of the following measurements
a RSRP (Reference Signal Received Power) on one or more downlink reference signals,
a RSRPP (Reference Signal Received Path Power) on one or more downlink reference signals,
a RSTD,
an AoD,
an AoA,
a RxTx time difference,
and wherein the user equipment is configured to report information on said one or more measurements to a network entity of the wireless communication system.

11. A user equipment according to claim 1,
wherein, using the machine-learning model or parameters of the machine-learning model, the user equipment is configured to determine its position and/or to determine a distance between the user equipment and another entity, for example another user equipment, of the wireless communication system, for example ranging information.

12. A user equipment according to claim 11,
wherein the user equipment is configured to receive the machine-learning model or the parameters of the machine-learning model from a network entity of the wireless communication system.

13. A user equipment according to claim 12,
wherein the machine-learning model represents a selected machine-learning model selected a from a set of machine-learning models, e.g., from a global pool of machine-learning models.

14. A user equipment according to claim 1,
wherein the user equipment is configured to select the machine-learning model from a set of machine-learning models, e.g., from a global pool of machine-learning models.

15. A user equipment according to claim 13,
wherein the user equipment is configured to receive a description or a configuration comprising the set of machine-learning models.

16. A user equipment according to claim 13,
wherein the set of machine-learning models comprises a plurality of machine-learning models, wherein each of the plurality of machine-learning models is a machine-learning model for a particular zone, e.g., for a particular region.

17. A user equipment according to claim 13,
wherein the user equipment is configured to select the machine-learning model from the set of machine-learning models depending on one or more measurements.

18. A user equipment according to claim 17,
wherein a result of the one or more measurements depends on the position of the user equipment.

19. A user equipment according to claim 11,
wherein the user equipment is configured to deploy the machine-learning model or a portion thereof, or the parameters of the machine-learning model or a portion thereof, to other user equipments, and/or
wherein the user equipment is configured to update the machine-learning model or a portion thereof, or the parameters of the machine-learning model or a portion thereof, during an interference phase, and/or
wherein the user equipment is configured to update the machine-learning model or a portion thereof, or the parameters of the machine-learning model or a portion thereof, in a global pool.

20. A user equipment according to claim 11,
wherein, during a training of the machine-learning model, the user equipment is configured to monitor an output of the machine-learning model.

21. A user equipment according to claim 20,
wherein the user equipment is configured to train a pre-trained model to obtain a trained model.

22. A user equipment according to claim 11,
wherein an input of the machine-learning model is at least one of:
one or more channel impulse response/s,
at least one TOA,
at least one AOA,
at least one AOD,
at least one TOT,
at least one TDOA.

23. A user equipment according to claim 11,
wherein the user equipment is configured to receive update information on the machine-learning model or on parameters of the machine-learning model from a network entity of the wireless communication system, and
wherein the user equipment is configured to update the machine-learning model or the parameters of the machine-learning model using the update information.

24. A user equipment according to claim 11,
wherein the user equipment is configured to receive training data from another user equipment, and
wherein the user equipment is configured to train and/or to retrain and/or to calibrate a machine-learning model using the training data.

25. A user equipment according to claim 1,
wherein the user equipment is configured to receive assistance data from a network entity of the wireless communication system, if the user equipment is located in a machine-learning assisted area.

26. A user equipment according to claim 25,
wherein the user equipment is configured to receive information from a network entity of the wireless communication system that said assistance data is available, if the user equipment is located in a machine-learning assisted area.

27. A user equipment according to claim 25,
wherein the user equipment is configured to receive as the assistance data one or more machine-learning model parameters of the following:
a machine-learning model, for example a type of a model,
a structure of the model, for example a type and/or a number of layers and structural dependencies thereof,
one or more features, for example input data, of a machine-learning model, one or more coefficients describing a machine-learning model and/or a part thereof,
additional assistance data in making measurement,
information to trigger the user equipment to provide additional measurements, for example as sensor unit.

28. A user equipment according to claim 1,
wherein the user equipment is configured to receive information from a network node of the wireless communication system comprising information that additional information from the user equipment is requested,
wherein the additional information for example comprises information associating the measurement from one positioning session to another positioning session and/or for example coherence between measurements, and
wherein the user equipment is configured to transmit the additional information.

29. A user equipment of a wireless communication system,
wherein the user equipment is configured to determine if it shall act as a temporal anchor unit, for example as a temporal anchor or as a temporal PRU or as a PRU, depending on the temporal reference information.

30. A user equipment according to claim 29,
wherein, if the user equipment has determined that it shall act as a temporal anchor unit, the user equipment exhibits information on its position, or another entity, for example a network entity, of the wireless communication system comprises information on the position of the user equipment and/or comprises information on a distance between the user equipment and another entity, for example another user equipment, of the wireless communication system, for example ranging information.

31. A user equipment according to claim 29,
wherein, if the user equipment has determined that it shall act as a temporal anchor unit, the user equipment is configured to transmit one or more reference signals to another user equipment of the wireless communication system, and/or is configured to receive one or more reference signals from the other user equipment, for example to determine position information on a position of the other user equipment, and/or to determine information on a distance between the user equipment and another entity, for example another user equipment, of the wireless communication system, for example ranging information.

32. A user equipment according to claim 29,
wherein, if the user equipment has determined that it shall act as a temporal anchor unit, the user equipment is configured to report, in a same positioning session,
information on its position, and/or to information on a distance between the user equipment and another entity, for example another user equipment, of the wireless communication system, for example ranging information; and
information on one or more measurements on a reference signal.

33. A user equipment according to claim 29,
wherein, if the user equipment has determined that it shall act as a temporal anchor unit, the user equipment is configured to receive a position reference signal from an entity of the wireless communication system, and/or the user equipment is configured to transmit a position reference signal to the entity, the entity being a network entity or another user equipment of the wireless communication system.

34. A user equipment according to claim 29,
wherein, if the user equipment has determined that it shall act as a temporal anchor unit, a network entity of the wireless communication system is able to determine the position of a device of the wireless communication system and/or to determine a distance between the user equipment and the device, by receiving reports on one or more measurements from the user equipment, for example one or more measurements performed on a position reference signal transmitted by other devices in the wireless communication system.

35. A user equipment according to claim 29,
wherein the user equipment is configured to receive a temporal reference information message from a network entity of the wireless communication system or from another user equipment of the wireless communication system,
wherein the temporal reference information message comprises the temporal reference information.

36. A user equipment according to claim 29,
wherein the user equipment has access to the temporal reference information without receiving the temporal reference information within a message.

37. A user equipment according to claim 29,
wherein the user equipment is configured to determine and/or to assist determining a position of another user equipment of the wireless communication system.

38. A user equipment according to claim 29,
wherein the temporal reference information comprises one or more condition criteria,
wherein the user equipment is configured to determine whether or not it shall act as a temporal anchor unit by determining for at least one condition criterion of the one or more condition criteria whether or not the user equipment satisfies said at least one condition criterion.

39. A user equipment according to claim 38,
wherein the one or more condition criteria comprise one or more of the following:
an indication on the positioning absolute or relative accuracy,
a certainty,
a position quality,
a protection level, which is a statistical upper-bound of the positioning error,
an integrity flagging, which is indication of whether protection level is larger than an alert limit or not.

40. A user equipment according to claim 38,
wherein the one or more condition criteria comprise a capability signaling to provide one or more of the following information:
a bearing,
an orientation,
a velocity,
an acceleration,
a motion state within a movement model, for example one of the states stationary, pedestrian, vehicular traffic, highway traffic.

41. A user equipment according to claim 29,
wherein, if the user equipment has determined that it shall act as a temporal anchor unit, the user equipment is configured to provide information that it is to act as a temporal anchor unit using PRU capability signaling to one of the network entities or one of the user equipments of the wireless communication system.

42. A user equipment according to claim 29,
wherein, if the user equipment has determined that it shall act as a temporal anchor unit, the user equipment is configured to report its position and/or to report one or more measurements and/or to transmit a position reference signal and/or to receive a position reference signal to/from an entity of the wireless communication system within a same positioning session and/or to report information on a distance between the user equipment and another entity, for example another user equipment, of the wireless communication system, for example ranging information.

43. A user equipment according to claim 29,
wherein, if the user equipment has determined that it shall act as a temporal anchor unit, the user equipment is configured to provide information to one of the entities of the wireless communication system for a machine-learning model for positioning.

44. A user equipment according to claim 29,
wherein, if the user equipment has determined that it shall act as a temporal anchor unit, the user equipment is configured to provide ACS information, for example, information on one or more characteristics of one or more transmission channels of the wireless communication system, and/or to provide information on a validity of ACS information for a particular region, to an entity of the wireless communication system.

45. An user equipment according to claim 29,
wherein, if the user equipment has determined that it shall not act as a temporal anchor unit, the user equipment is configured to refrain from reporting its position to an entity of the wireless communication system, and/or is configured to report to an entity of the wireless communication system that it will not act as a temporal anchor unit; and/or
wherein, if the user equipment has determined that it shall no longer act as a temporal anchor unit, the user equipment is configured to refrain from reporting its position to an entity of the wireless communication system, and/or is configured to report to an entity of the wireless communication system that it will no longer act as a temporal anchor unit.

46. A user equipment according to claim 29,
wherein the user equipment is capable to transmit information on its position, and/or is capable to transmit information on a distance between the user equipment and another entity, for example another user equipment, of the wireless communication system, for example ranging information.

47. A user equipment according to claim 29,
wherein the user equipment is configured to inform the network about its capability to become a temporal anchor unit.

48. A user equipment according to claim 29,
wherein if one or more predefined conditions are fulfilled, the user equipment is configured to inform the network that the condition for the UE to act as a PRU is fulfilled, and/or the user equipment is configured to begin to send measurements to a network entity or to another user equipment of the wireless communication system, for example, so that the user equipment acts as a temporal anchor or a PRU.

49. A user equipment according to claim 29,
wherein the user equipment is configured to acquire its position using a first positioning method, for example a GNSS and/or a iGPS and/or a RAT dependent positioning method, and/or using reference information, for example O&M, and is configured to provide reference measurements and/or to transmit signals for collecting reference measurements to a network entity and/or to another user equipment of the wireless communication system, for example, to fulfil the condition for being a PRU.

50. A user equipment according to claim 29,
wherein the user equipment is configured to receive a request, for example from a network entity of the wireless communication system, to act as a temporal anchor unit for another device.

51. A user equipment according to claim 29,
wherein the user equipment is configured to conduct RTT measurements.

52. A user equipment according to claim 29,
wherein the user equipment is configured to conduct one or more measurements for one or more sidelinks with one or more other user equipments of the wireless communication system.

53. A user equipment according to claim 52,
wherein the one or more measurements measure a sidelink range and/or provide direction information between the user equipment and another user equipment to be located.

54. A user equipment according to claim 29,
wherein the user equipment is configured to employ a RAT-independent technology to determine a range and/or direction, and is configured to inform a network entity of the wireless communication system or another device that the ranging and/or directional information is obtained using a RAT-independent technology.

55. A user equipment according to claim 54,
wherein the user equipment is configured to employ one or more of the following ranging technologies as the RAT-independent technology:
UWB,
Lidar,
Radar,
a WLAN based ranging.

56. A user equipment of a wireless communication system,
wherein the user equipment is configured to obtain information on its position and/or to obtain information on a distance between the user equipment and another entity, for example another user equipment, of the wireless communication system, for example ranging information,
by receiving, for example via a direct communication link or indirectly through the network, information from another user equipment which acts as a temporal anchor unit, for example a temporal anchor or a temporal PRU or a PRU, wherein said information received from the temporal anchor unit comprises a position of the temporal anchor unit and/or one or more measurements performed by the temporal anchor unit on signals transmitted by the user equipment, or wherein said information comprises a position reference signal, and
by performing one or more measurements on one or more received signals, and/or by transmitting to a network entity, for example to a LMF or to a NWDAF, derived information derived from said measurements of the wireless communication system.

57. A user equipment according to claim 56,
wherein the user equipment is configured to determine its position itself, for example by employing user equipment based OTDOA, and/or is configured to report its position to a network entity of the wireless communication system,
wherein the user equipment is configured to perform and/or to report one or more measurements on the one or more received signals, being one or more downlink signals.

58. A user equipment of a wireless communication system,
wherein the user equipment, for example being an UL-TDOA device, is configured to support an entity, for example a network entity, of the wireless communication system to obtain information on a position of the user equipment and/or to obtain information on a distance between the user equipment and another entity, for example another user equipment, of the wireless communication system, for example ranging information,
by transmitting, for example via a direct communication link or indirectly through the network, one or more reference signals to a another user equipment which acts as a temporal anchor unit, for example a temporal anchor or a temporal PRU or a PRU, to allow the temporal anchor to conduct one or more measurements on the one or more reference signals and/or to report the one or more measurements to said entity of the wireless communication system.

59. A user equipment of a wireless communication system,
wherein the user equipment is configured to determine, for example by using a RAT-independent technology and/or by using a RAT-dependent technology and/or by using a temporal anchor, or is configured to receive, information on its position, and/or information on a distance between the user equipment and another entity, for example another user equipment, of the wireless communication system, for example ranging information, and
wherein the user equipment is configured to assist in generating training data for a machine-learning model for positioning using the information on its position and/or the information on said distance, for example for machine learning with related labels,
for example wherein the machine-learning model is located on an LMF or on a NWDAF of the wireless communication system.

60. A user equipment according to claim 59,
wherein the user equipment is configured to employ information on one or more channel impulse responses to assist in generating training data for the machine-learning model.

61. A user equipment according to claim 60,
wherein the user equipment is configured to transmit information one the one or more channel impulse responses and information on its position and/or on said distance to an entity, for example a network entity, of the wireless communication system to assist in generating training data for the machine-learning model.

62. A user equipment of a wireless communication system,
wherein the user equipment is configured to transmit information on one or more properties of RF channel characteristics between the user equipment and another entity of the wireless communication system and/or an indicator on the probability that a direct path (“line-of-sight” path) exists and/or information on the characteristics of one or more RF channel propagation paths not related to the direct path, wherein the other entity of the wireless communication system is a base station or is another user equipment of the wireless communication system,
wherein the user equipment is configured to report, to said other entity or to a further entity of the wireless communication system, information on one or more channel impulse responses.

63. A user equipment according to claim 56,
wherein the user equipment is configured to report to a network entity of the wireless communication system one or more signal characteristics of at least one received reference signal comprising at least one of the following information
a signal strength,
a LOS/NLOS probability,
an information on one or more received beams,
a similarity of two or more, for example consecutive, beams,
one or more channel impulse response parameters,
a similarity of two or more, for example consecutive, channel impulse responses,
one or more estimates on a distance and/or an orientation,
a motion profile,
a signal classification, for example depending on confidence information.

64. A user equipment according to claim 56,
wherein the user equipment is configured to employ a measurement on a DL-reference signal during conducting or supporting an execution of a DL-TDOA, and/or a multi-RTT and/or a DL-AoD method.

65. A user equipment according to claim 56,
wherein, if a number of TRPs with LOS conditions are not sufficient, the user equipment is configured to indicate to a network entity of the wireless communication system that the number of TRPs with LOS conditions are not sufficient.

66. A user equipment according to claim 56,
wherein the user equipment is configured to receive information from an entity of the wireless communication system to communication with another user equipment that acts as a temporal anchor unit, for example, as a temporal anchor or as a temporal PRU or as a PRU, to obtain information on its position, and/or to obtain information on a distance between the user equipment and another entity, for example another user equipment, of the wireless communication system, for example ranging information.

67. A user equipment according to claim 56,
wherein the user equipment is a sensor unit and/or wherein the user equipment has sensor unit capabilities.

68. A user equipment according to claim 56,
wherein said other user equipment which acts as a temporal anchor unit is a user equipment according to claim 18.

69. A user equipment according to claim 56,
wherein the user equipment is configured to receive and process information on one or more available temporal anchor units.

70. A user equipment according to claim 56,
wherein the user equipment is configured to transmit a PRS signal synchronized to a network entity of the wireless communication system to another entity, for example a sidelink PRS to another user equipment, of the wireless communication system.

71. A user equipment according to claim 56,
wherein the user equipment is configured to measure a time of arrival on SRS signals relative to a network clock of the wireless communication system.

72. A user equipment according to claim 1,
wherein the user equipment is configured as a user equipment according to claim 29.

73. A user equipment according to claim 29,
wherein the user equipment is configured to receive a machine-learning model or parameters of the machine-learning model from a network entity of the wireless communication system, and
wherein the user equipment is configured to determine its position using the machine-learning model or the parameters of the machine-learning mode, and/or wherein the user equipment is configured to determine a distance between the user equipment and another entity, for example another user equipment, of the wireless communication system, for example ranging information.

74. A user equipment according to claim 73,
wherein the user equipment is configured to receive update information on the machine-learning model or on parameters of the machine-learning model from a network entity of the wireless communication system, and
wherein the user equipment is configured to update the machine-learning model or the parameters of the machine-learning model using the update information.

75. A user equipment according to claim 73,
wherein the user equipment is configured to receive training data from another user equipment, and
wherein the user equipment is configured to train and/or to retrain and/or to calibrate a machine-learning model using the training data.

76. A user equipment according to claim 1,
wherein the user equipment is configured to report its position and/or to report one or more measurements and/or to transmit a position reference signal and/or to receive a position reference signal to/from another user equipment of the wireless communication system via a sidelink and/or to report information on a distance between the user equipment and another entity, for example another user equipment, of the wireless communication system, for example ranging information.

77. A user equipment according to claim 1,
wherein the user equipment is configured to transmit training data to a network entity of the wireless communication system to train and/or to retrain and/or to calibrate a machine-learning model.

78. A user equipment according to claim 1,
wherein the user equipment is configured to transmit training data to another user equipment of the wireless communication system to train and/or to retrain and/or to calibrate a machine-learning model.

79. A user equipment of a wireless communication system,
wherein the user equipment is configured to receive measurement and/or transmission characteristics information.

80. A user equipment according to claim 79,
wherein the user equipment comprises and/or implements a measurement device, and is configured to receive measurement and/or transmission characteristics information, which enables the measurement device to identify one or more measurement characteristics.

81. A user equipment according to claim 79,
wherein the user equipment comprises and/or implements a transmission device, and is configured to transmit a PRS, which enables the network to identify and/or to generate training data for model calibration.

82. A user equipment according to claim 79,
wherein the measurement and/or transmission characteristics information is associated with one or more TRPs and is further associated with a geographical region.

83. A user equipment according to claim 79,
wherein the measurement and/or transmission characteristics information is ACS information (Association and Calibration Spots information).

84. A user equipment according to claim 83,
wherein the ACS information is associated with one or more TRPs and is further associated with a geographical region.

85. A user equipment according to claim 79,
wherein the user equipment is configured to determine for the measurement and/or transmission characteristics information, whether the measurement and/or transmission characteristics information is valid for the region in which the user equipment is located.

86. A user equipment according to claim 79,
wherein the user equipment is configured to conduct and/or to report one or measurements of one or more reference signals depending on the measurement and/or transmission characteristics information.

87. A user equipment according to claim 79,
wherein the user equipment is configured to receive the measurement and/or transmission characteristics information comprising power information on a power level of a given path, for example wherein the power information is absolute or is relative with respect to one or more resources or multiple paths within a resource or within a measurement,
wherein the user equipment is configured to use this information to detect the indicated path and/or to determine its position and/or to report measurements related to the detected path; and/or to determine information on a distance between the user equipment and another entity, for example another user equipment, of the wireless communication system, for example ranging information.

88. A user equipment according to claim 79,
wherein the user equipment is configured to use the measurement and/or transmission characteristics information to set a detection method or a detection threshold to derive a ToA and/or a RSRPP and/or an AoA.

89. A user equipment according to claim 79,
wherein the measurement and/or transmission characteristics information comprises at least one indication on a delay and/or a direction of a non-LOS path.

90. A user equipment according to claim 79,
wherein the measurement and/or transmission characteristics information comprises at least one indication on a plurality of beams detectable in a region, e.g., an ACS region.

91. A user equipment according to claim 90,
wherein the plurality of beams are associated with one or more expected channel conditions which comprise one or more of the following:
a soft or a hard value indication for LOS or NLOS conditions per beam,
an expected Power level per each beam, for example RSRPP and/or RSRP.

92. A user equipment according to claim 90,
wherein the plurality of beams are associated with an indicated antenna radiation information of the main, null or side lobes provided to the user equipment.

93. A user equipment according to claim 1,
wherein the user equipment is configured to receive information on two or more antennas of a same TRP of the wireless communication system and/or on two or more antennas of a same user equipment of the wireless communication system.

94. A user equipment of a wireless communication system,
wherein the user equipment is configured to receive from a network entity of the wireless communication system one or more PRS configurations for one or more antennas of one or more transmitting devices of the wireless communication system,
wherein the user equipment is configured to receive from a network entity of the wireless communication system measurement and/or transmission characteristics information comprising a set of one or more parameters, and
wherein the user equipment is configured to determine, using the one or more PRS configurations and using the measurement and/or transmission characteristics information, its position and/or information on a distance between the user equipment and another entity, for example another user equipment, of the wireless communication system, for example ranging information.

95. A user equipment according to claim 94,
wherein the user equipment comprises and/or implements a measurement device, and is configured to receive measurement and/or transmission characteristics information, which enables the measurement device to identify one or more measurement characteristics.

96. A user equipment according to claim 94,
wherein the measurement and/or transmission characteristics information is ACS information (Association and Calibration Spots information).

97. A user equipment according to claim 79,
wherein the user equipment is configured to select a portion of the measurement and/or transmission characteristics information as a subset of the measurement and/or transmission characteristics information.

98. A user equipment according to claim 97,
wherein the user equipment is configured to select the subset of the measurement and/or transmission characteristics information depending on information received from a network entity of the wireless communication system and/or depending on information derived from a sidelink and/or depending on information derived from an uplink reference signal and/or depending on movement type or velocity information or orientation information or pressure information.

99. A user equipment according to claim 79,
wherein the user equipment is configured to receive a first portion of the measurement and/or transmission characteristics information, and
wherein the user equipment is configured to receive a second portion of the measurement and/or transmission characteristics information after the first portion, wherein the second portion comprises more detailed information than the first portion.

100. A user equipment according to claim 79,
wherein the measurement and/or transmission characteristics information comprises one or more of the following:
one or more delay paths for the LOS and/or multipath components,
one or more directional paths LOS and/or multipath components,
power/Magnitude information for one or more directional and delay path associated with one resource or one path per resource,
expected LOS delay and magnitude to a multipath component such as the maximum peak expected by a given resource,
window configuration indicating the expected delay or direction of the LOS or multipath to be applied on the measurements or to be reported,
window configuration indicating the expected delay or direction of the LOS or multipath not to be applied on the measurements or to be reported,
a validity region with information on the validity where the information can be soft or hard values,
correlation of measurement and/or transmission characteristics information in a given area and number of updates measurement and/or transmission characteristics information needed or expected,
an indication from a measurement unit.

101. A user equipment according to claim 79,
wherein the user equipment is a sensor unit and/or wherein the user equipment has sensor unit capabilities.

102. A user equipment according to claim 79,
wherein the user equipment is configured as a user equipment according to claim 1.

103. A network entity of a wireless communication system,
wherein the network entity is configured to transmit to a user equipment of the wireless communication system temporal reference information for enabling the user equipment to determine if it is able to act as a temporal anchor unit, for example as a temporal anchor or as a temporal PRU or as a PRU,
wherein, if the user equipment has determined that it shall act as a temporal anchor unit, the network entity is configured to receive from the user equipment information on its position and/or on one or more measurements and/or on a position reference signal; and/or on a distance between the user equipment and another entity, for example another user equipment, of the wireless communication system, for example ranging information.

104. A network entity of a wireless communication system,
wherein the network entity is configured to receive information from a user equipment of the wireless communication system on one or more line-of-sight links, for example defined by that an RF channel including a direct path with a delay according to the distance, or on one or more properties or one or more characteristics of one or more RF channels between network entities or a non-presence of a line-of-sight links to another entity, for example to another network entity, of the wireless communication system.

105. A network entity of a wireless communication system,
wherein the network entity is configured to transmit information that a user equipment of the wireless communication system is located in a machine-learning assisted area.

106. A network entity according to claim 105,
wherein the network entity is configured to store one or more identifiers of a user equipment of the wireless communication system which is entering a machine-learning-assisted area,
wherein the network entity is configured to deleting the identifier of the user equipment leaving the machine-learning-assisted area,
wherein the network entity or another entity of the wireless communication system is configured to obtain the identifier of at least one user equipment located inside the machine-learning-assisted area to initiate procedures to train a machine-learning model and/or to update the machine-learning model.

107. A network entity according to claim 106,
wherein the network entity is configured to transmit a machine-learning model or parameters of the machine-learning model to the user equipment.

108. A network entity according to claim 106,
wherein the network entity is configured to receive training data from the user equipment, and
wherein the network entity is configured to train and/or to retrain and/or to calibrate a machine-learning model using the training data.

109. A network entity of a wireless communication system,
wherein, if a user equipment of the wireless communication system shall act as a temporal anchor unit,
the network entity is configured to receive information on one or more measurements from the user equipment, for example one or more measurements performed on a position reference signal transmitted by the device, and
the network entity is configured to determine a position of the device and/or to determine a distance between the user equipment and the device, using information on a position of the user equipment and using the information on the one or more measurements.

110. A network entity of a wireless communication system,
wherein the network entity is configured to transmit measurement and/or transmission characteristics information, for example, ACS information (Association and Calibration Spots information), to a user equipment of the wireless communication system, wherein the measurement and/or transmission characteristics information is associated with one or more TRPs and is further associated with a geographical region.

111. A network entity of a wireless communication system,
wherein the network entity is configured to transmit to a user equipment of the wireless communication system one or more PRS configurations for one or more antennas of one or more transmitting devices of the wireless communication system, and
wherein the network entity is configured to transmit to the user equipment of the wireless communication system measurement and/or transmission characteristics information, for example, ACS information (Association and Calibration Spots information), comprising a set of one or more parameters, for example wherein the measurement and/or transmission characteristics information comprises information on the relationship between an ACS-ID and assistance data, for example wherein the assistance data comprises a PRS configuration.

112. A network entity according to claim 103,
wherein the NW entity is any one of the following:
a NWDAF,
a LMF,
a NRF,
a NEF,
a NG-RAN,
an AMF,
a GMLC,
a UDM.

113. A wireless communication system, comprising:
one or more user equipments according to claim 1, and
one or more network entities according to claim 103.

114. A wireless communication system,
wherein the wireless communication system comprises at least two entities, wherein each of the at least two entities is a user equipment or is a network entity, wherein the at least two entities comprise a first entity and a second entity,
wherein the first entity is configured to determine, if it shall act as a temporal anchor unit, for example as a temporal anchor or as a temporal PRU or as a PRU, depending on temporal reference information,
wherein the second network entity is configured to perform one or more measurements and is configured to provide one or more reports derived from the one or more measurements to a another network entity, for example to an LMF or to an NWDAF, to train a model, for example neural network, or to capture the characteristics of one or more RF signals received in an area.

115. A wireless communication system according to claim 114,
wherein the first entity, for example a temporal anchor, is configured to transmit and/or is configured to receive one or more reference signals to/from the second entity as information, and
wherein the second entity is configured to employ this information to determine its position; and/or to determine information on a distance between the second entity and another entity, for example another user equipment, of the wireless communication system, for example ranging information.

116. A wireless communication system according to claim 114,
wherein the first entity, for example a temporal anchor, is configured to provide information on the one or more measurements performed on the one or more reference signals received, and/or is configured to report the characteristics of the one or more reference signals received to the second entity as information, and
wherein the second entity is configured to employ this information to determine its position relative to the first entity; and/or to determine a distance between the second entity and the first entity, for example ranging information.

117. A wireless communication system according to claim 113,
wherein the first entity is a user equipment according to claim 1 and the second entity is a network entity according to claim 103, or
wherein the second entity is a user equipment according to claim 1 and the first entity is a network entity according to claim 103.

118. A wireless communication system comprising a plurality of entities,
wherein at least one of the plurality of entities is configured to use one or more measurements of one or more user equipments of the wireless communication system for conducting one or more comparisons,
wherein at least one of the plurality of entities is configured to conduct unsupervised learning of similar properties or characteristics, for example of one or more channel impulse responses or one or more parameters thereof,
wherein at least one of the plurality of entities is configured to employ one or more temporal anchors of the wireless communication system are used for supervised learning,
wherein at least one of the plurality of entities is configured to conduct supervised learning for mapping similar properties or characteristics, for example of a channel impulse responses or of parameters thereof, to corresponding reference information, for example to a velocity and/or to an orientation and/or to an acceleration and/or to a position and/or to a distance,
wherein at least one of the plurality of entities is configured to train or to collect a ML-model using a combination of supervised, for example with output labels, and unsupervised, for example without output labels, approaches,
wherein at least one of the plurality of entities is configured to employ labels that are obtained from one or more temporal anchors are to provide real world dimensions to the trained model, wherein the labels allow to transform, for example to scale and to rotate, the learned representation to a real-world dimension.

119. A wireless communication system according to claim 118,
wherein the plurality of entities comprises a user equipment according to claim 1 and a network entity according to claim 103.

120. A method for a wireless communication system,
wherein the method comprises determining, by a user equipment of the wireless communication system, and/or receiving, by the user equipment, information on an applicability of a machine-learning model, and/or
wherein the method comprises determining, by a user equipment of the wireless communication system, and/or receiving, by the user equipment, information that the user equipment is located in a machine-learning assisted area.

121. A method for a wireless communication system,
wherein the method comprises determining if a user equipment of the wireless communication system shall act as a temporal anchor unit, for example as a temporal anchor or as a temporal PRU or as a PRU, depending on the temporal reference information.

122. A method for a wireless communication system,
wherein the method comprises obtaining, by a user equipment of the wireless communication system, information on its position and/or to obtain information on a distance between the user equipment and another entity, for example another user equipment, of the wireless communication system, for example ranging information,
by receiving, for example via a direct communication link or indirectly through the network, information from another user equipment which acts as a temporal anchor unit, for example a temporal anchor or a temporal PRU or a PRU, wherein said information received from the temporal anchor unit comprises a position of the temporal anchor unit and/or one or more measurements performed by the temporal anchor unit on signals transmitted by the user equipment, or wherein said information comprises a position reference signal, and
by performing one or more measurements on one or more received signals, and/or by transmitting to a network entity, for example to a LMF or to a NWDAF, derived information derived from said measurements of the wireless communication system.

123. A method for a wireless communication system,
wherein the method comprises supporting, by a user equipment of the wireless communication system, information an entity, for example a network entity, of the wireless communication system to obtain information on a position of the user equipment and/or to obtain information on a distance between the user equipment and another entity, for example another user equipment, of the wireless communication system, for example ranging information,
by transmitting, for example via a direct communication link or indirectly through the network, one or more reference signals to a another user equipment which acts as a temporal anchor unit, for example a temporal anchor or a temporal PRU or a PRU, to allow the temporal anchor to conduct one or more measurements on the one or more reference signals and/or to report the one or more measurements to said entity of the wireless communication system.

124. A method for a wireless communication system,
wherein the method comprises determining, for example by using a RAT-independent technology and/or by using a RAT-dependent technology and/or by using a temporal anchor, or receiving, by a user equipment of the wireless communication system, information on a position of the user equipment, and/or information on a distance between the user equipment and another entity, for example another user equipment, of the wireless communication system, for example ranging information, and
assisting, by the user equipment, in generating training data for a machine-learning model using the information on its position and/or the information on said distance, for example for machine learning with related labels,
for example wherein the machine-learning model is located on an LMF or on a NWDAF of the wireless communication system.

125. A method for a wireless communication system,
wherein the method comprises transmitting, by a user equipment of the wireless communication system, information on one or more properties of RF channel characteristics between the user equipment and another entity of the wireless communication system and/or an indicator on the probability that a direct path (“line-of-sight” path) exists and/or information on the characteristics of one or more RF channel propagation paths not related to the direct path, wherein the other entity of the wireless communication system is a base station or is another user equipment of the wireless communication system,
wherein the method comprises reporting, by the user equipment to said other entity or to a further entity of the wireless communication system, information on one or more channel impulse responses.

126. A method for a wireless communication system,
wherein the method comprises receiving, by a user equipment, measurement and/or transmission characteristics information.

127. A method for a wireless communication system,
wherein the method comprises receiving, by a user equipment, from a network entity of the wireless communication system one or more PRS configurations for one or more antennas of one or more transmitting devices of the wireless communication system,
wherein the method comprises receiving, by the user equipment, from a network entity of the wireless communication system measurement and/or transmission characteristics information comprising a set of one or more parameters, and
wherein the method comprises determining, by the user equipment, using the one or more PRS configurations and using the measurement and/or transmission characteristics information, its position and/or information on a distance between the user equipment and another entity, for example another user equipment, of the wireless communication system, for example ranging information.

128. A computer program for implementing the method of claim 120, when the computer program is executed by a computer or signal processor.
